(19) United States
(12) Patent Application Publication
(10) Pub. No.: US 2016/0077481 A1
(43) Pub. Date: Mar. 17, 2016

(54) SHEET PROCESSING APPARATUS AND IMAGE FORMING APPARATUS

(71) Applicant: CANON KABUSHIKI KAISHA, Tokyo (JP)

(72) Inventors: Shingo Katano, Toride-shi (JP); Koji Takematsu, Abiko-shi (JP); Kenjiro Sugaya, Moriya-shi (JP)

(21) Appl. No.: 14/854,944

(22) Filed: Sep. 15, 2015

(30) Foreign Application Priority Data
Sep. 16, 2014 (JP) 2014-187923

(51) Int. Cl. G03G 15/00

(52) U.S. Cl. CPC G03G 15/6576

(57) ABSTRACT

A sheet processing apparatus includes a first roller pair configured to nip a sheet at a nip portion and convey the sheet, and a second roller pair disposed on a downstream side of the first roller pair in a sheet conveyance direction and configured to nip the sheet at a nip portion and convey the sheet. When the sheet is nipped by the first and the second roller pairs, a bending stress occurs on the sheet.

### BACKGROUND OF THE INVENTION

1. Field of the Invention

The present invention relates to a sheet processing apparatus for processing a sheet, and an image forming apparatus (a copying machine, a printer, a facsimile, etc.) provided with the sheet processing apparatus.

2. Description of the Related Art

Conventionally, an electrophotographic image forming apparatus develops latent images formed on photosensitive drums as image-bearing members to form visible images, and transfers the visible images (toner images) onto a sheet by using electrostatic force. Subsequently, the image forming apparatus fixes a resultant toner image onto the sheet with heat and pressure to record the image on the sheet.

Such an image forming apparatus includes a fixing apparatus employing a heat roller fixing system. More specifically, a pressure roller having elasticity comes in pressure-contact with a fixing roller (incorporating a heat source such as a heater) maintained at a predetermined temperature to form a fixing nip portion at which the toner image is fixed onto the sheet.

In recent years, in image forming apparatuses (particularly full color image forming apparatuses) employing a fixing apparatus of this type, a fixing apparatus capable of prolonging the heating time period and increasing the fixing speed from a viewpoint of improving coloring property and image quality of toner images is known. For example, as discussed in Japanese Patent Application Laid-Open No. 5-150679, there is known a fixing apparatus, what is called a belt nip type fixing apparatus, in which an endless fixing belt stretched by a plurality of rollers comes in pressure-contact with a heating roller.

Further, recent years have seen the demand for increasing the process speed to improve the output speed of image forming apparatuses. For this reason, a larger nip width is required in the width direction perpendicularly intersecting with the sheet conveyance direction. A belt fixing system ensuring a large nip width in such a manner that the fixing roller or the pressure roller or both are replaced with an endless belt has been proposed and commercially produced.

In the thermal fixing process of these fixing apparatuses, since heat and pressure are applied to a sheet having a toner image transferred thereon, moisture evaporates from inside of the sheet at a pressure-contact nipping portion and after the sheet passes through the pressure-contact nip portion. A change of the amount of sheet moisture as a result of heat of the sheet and together with the stress applied to the sheet by pressure in this process causes a phenomenon (called a curl) in which the sheet curves and a phenomenon (called a wave) in which the sheet undulates.

The following is a description about sheet-like paper most commonly used as a sheet on the fiber level. Paper is composed of short fibers entangled with each other, and moisture exists inside fibers and between fibers. Further, since fibers and water are in an equilibrium state where hydrogen bonds are formed, smoothness is maintained.

When heat and pressure are applied to the sheet in the fixing process, fibers are displaced by pressure. When heat is applied to the sheet in this state, moisture evaporates and hydrogen bonds are further formed between fibers whereby sheet deformation is caused. If the sheet is left to stand, it absorbs moisture from environment, and hydrogen bonds between fibers are separated again. Thus, the sheet is likely to return to the former state. However, since moisture does not enter between some paper fibers, the sheet deformation is maintained. As described above, there are two different deformation patterns: a curl and a wave. A curl occurs by expansion and contraction differences between the front and back surfaces of the sheet. A wave occurs by expansion and contraction differences between the sheet center and the sheet edges.

The primary cause of a wave occurring at the sheet edges lies in the process of sheet passing through the nip portion of the fixing apparatus. For example, in the case of a fixing apparatus having a wide nip as in a belt fixing system, to prevent wrinkles on the sheet in the process of sheet passing through the nip portion, the sheet conveyance speed setting at the sheet edges is set higher than the sheet conveyance speed setting at the sheet center in the width direction perpendicularly intersecting with the sheet conveyance direction in the nip portion. As a result, in a case where a frictional action is applied to the sheet, the sheet edges expand in the sheet conveyance direction to a further extent than the proximity of the sheet center after sheet passes through the nip portion whereby a wave occurs at the sheet edges.

The secondary cause of a wave occurring at the sheet edges lies in the process after sheet passes through the nip portion of the fixing apparatus. In a state where a sheet bundle is stacked, each sheet contacts the atmosphere and moisture quickly moves in and out at the sheet edges. On the other hand, sheets are stacked and therefore moisture is not likely to move in and out at the sheet center. Accordingly, after heat is applied to the sheet in the fixing process and moisture inside the sheet evaporates, the sheet quickly absorbs moisture from the sheet edges. As a result, the sheet edges expand in the sheet conveyance direction to a further extent than the proximity of the sheet center whereby a wave occurs at the sheet edges (hereinafter referred to as a wave).

In order to solve such a wave problem, there is known a sheet processing apparatus discussed in International Publication No. WO2014/069307 in which a tension is applied to a sheet in the sheet conveyance direction, so that waves are reduced.

However, in the sheet processing apparatus configuration discussed in International Publication No. WO2014/069307, there has been a problem of difficulty in applying a sufficient tension to a sheet because a plurality of roller pairs for pulling the sheet is arranged straight in the sheet conveyance direction.

The present invention is directed to a technique for efficiently applying a tension to a sheet in a configuration of pulling the sheet as measures for preventing sheet waves.

### SUMMARY OF THE INVENTION

According to an aspect of the present invention, the present invention includes a first rotary member pair configured to nip a sheet at a nip portion and convey the sheet, a second rotary member pair disposed on a downstream side of the first rotary member pair in a sheet conveyance direction, and configured to nip the sheet at a nip portion and convey the sheet, and a loading unit configured to, when the sheet is nipped by the first and the second rotary member pairs, apply a load to a rotation of the first rotary member pair so that a tensile stress occurs on the sheet being conveyed by the second rotary member pair, wherein, when the sheet is nipped by the first and the second rotary member pairs, a bending stress occurs on the sheet.

According to another aspect of the present invention, image forming apparatus includes a fixing unit configured to thermally fix an unfixed image formed on a sheet, and the above-described sheet processing apparatus configured to perform processing on the sheet having the image fixed thereon.

Further features of the present invention will become apparent from the following description of exemplary embodiments with reference to the attached drawings.

### BRIEF DESCRIPTION OF THE DRAWINGS

FIGS. 1A, 1B, and 1C are schematic views each illustrating a problem.

FIG. 2 is a sectional view illustrating an electrophotographic printer according to a first exemplary embodiment.

FIG. 3 is a block diagram illustrating control of a printer and a sheet wave correction apparatus according to the first exemplary embodiment.

FIG. 4 is a sectional view illustrating a humidifying apparatus according to the first exemplary embodiment.

FIG. 5 is a sectional view illustrating a sheet pulling and conveying apparatus according to the first exemplary embodiment.

FIG. 6 is a sectional view illustrating a conveyance path in the sheet pulling and conveying apparatus according to the first exemplary embodiment.

FIG. 7 is a perspective view illustrating the sheet pulling and conveying apparatus according to the first exemplary embodiment.

FIG. 8 is another perspective view illustrating the sheet pulling and conveying apparatus according to the first exemplary embodiment.

FIG. 9A is a diagram illustrating an experimental configuration for studying a difference in sheet expansion when a bending stress is applied to a sheet, and FIG. 9B is a diagram illustrating an experimental result.

FIGS. 10A, 10B, 10C, and 10D are tables each illustrating results of an effect verification experiment for the sheet pulling and conveying apparatus.

FIG. 11 is a diagram illustrating a measurement method used in the effect verification experiment for the sheet pulling and conveying apparatus.

FIG. 12 is a sectional view illustrating a decurling device according to the first exemplary embodiment.

FIG. 13 is a sectional view illustrating a sheet pulling and conveying apparatus according to a second exemplary embodiment.

FIG. 14 is a sectional view illustrating a conveyance path in the sheet pulling and conveying apparatus according to the second exemplary embodiment.

FIG. 15 is a sectional view illustrating a sheet pulling and conveying apparatus according to a third exemplary embodiment.

FIG. 16 is a sectional view illustrating a conveyance path in the sheet pulling and conveying apparatus according to the third exemplary embodiment.

FIG. 17A is a diagram illustrating an experimental configuration for studying a force required to stably convey a sheet, and FIG. 17B is a diagram illustrating an experimental result.

FIG. 18 is a sectional view illustrating a conveyance path in a sheet pulling and conveying apparatus according to a fourth exemplary embodiment.

FIG. 19 is a sectional view illustrating a conveyance path in a sheet pulling and conveying apparatus according to a fifth exemplary embodiment.

### DESCRIPTION OF THE EMBODIMENTS

Preferred exemplary embodiments of the present invention will be described in detail below with reference to the accompanying drawings. However, sizes, materials, shapes, and relative arrangements of elements described in the following exemplary embodiments are not limited thereto, and should be modified as required depending on the configuration of an apparatus according to the present invention and other various conditions. Therefore, unless otherwise specifically described, the scope of the present invention is not limited to the following exemplary embodiments.

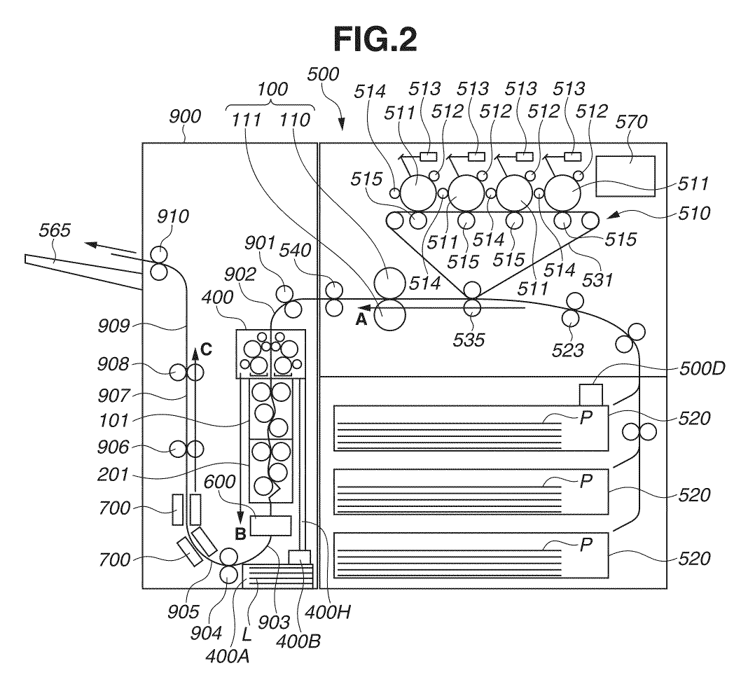

An image forming apparatus provided with a sheet processing apparatus according to a first exemplary embodiment will be described below with reference to FIGS. 2 to 4. The following is first describes about the image forming apparatus and then the sheet processing apparatus. The present exemplary embodiment will be described below based on an image forming apparatus including a main body of an image forming apparatus that includes image forming units, and a sheet processing apparatus externally connected to the image forming apparatus. However, an image forming apparatus configuration in which the sheet processing apparatus is integrated with the main body of the image forming apparatus is also applicable to the present invention.

As an example of an image forming apparatus, a main body of an image forming apparatus and a sheet processing apparatus detachably connected to the main body of the image forming apparatus will be described below with reference to FIG. 2. FIG. 2 is a diagram schematically illustrating a color electrophotographic printer 500 as an example of a main body of an image forming apparatus, and a sheet wave correction apparatus 900 as an example of a sheet processing apparatus. FIG. 2 is a sectional view perpendicular to the surface of a conveyed sheet and parallel to the sheet conveyance direction. Hereinafter, unless otherwise noted, sectional views of apparatuses are sectional views taken in this direction. The sheet wave correction apparatus 900 includes sheet pulling and conveying apparatuses 101 and 201 (tension applying apparatuses) and a sheet humidifying device (moisture applying unit) 400. In the following descriptions, a color electrophotographic printer is simply referred to as a “printer.”

A toner image is formed on a sheet. Examples of sheets include plain paper, resin sheet-shape paper as a substitute of plain paper, thick paper, and paper for an overhead projector.

The printer 500 illustrated in FIG. 2 includes image forming units 510 corresponding to colors yellow (Y), magenta (M), cyan (C), and black (Bk) respectively. Each of the image forming units 510 forms a toner image of corresponding color on a sheet. An intermediate transfer belt 531 having an endless shape as an intermediate transfer member is disposed in such a manner that the intermediate transfer belt 531 faces the image forming units 510. More specifically, the image forming apparatus employs a tandem system in which processes up to visible image formation for respective colors are performed in parallel.

The order of arrangement of the image forming units 510 for colors Y, M, C, and K is not limited to the order of arrangement illustrated in FIG. 2. The present invention is applicable not only to an image forming apparatus of the full color intermediate transfer type illustrated in FIG. 2 but also to a monochrome image forming apparatus.

Each of the image forming units 510 for respective colors illustrated in FIG. 2 is provided with the following process units. Each of the image forming units 510 includes an electrophotographic photosensitive member (hereinafter referred to as a photosensitive drum) 511 as an image-bearing member for bearing an electrostatic latent image of corresponding color Y, M, C, or K on the sheet surface, an charging roller 512, a laser scanner 513, and a developing unit 514. The photosensitive drum 511 is pre-charged by the charging roller 512. Subsequently, the photosensitive drum 511 is exposed to light by the laser scanner 513, and a latent image is formed thereon. The latent image is developed by the developing unit 514 to be visualized as a toner image.

At a primary transfer portion at which the photosensitive drums 511 face primary transfer rollers 515, toner images formed on the surfaces of the respective photosensitive drums 511 illustrated in FIG. 2 are primarily transferred one by one onto the intermediate transfer belt 531 by the primary transfer rollers 515.

Meanwhile, a sheet P is fed from a sheet cassette 520 illustrated in FIG. 2 and sent to a resist roller pair 523. The resist roller pair 523 once receives the sheet P and, if it is skewed, corrects the skew. Then, in synchronization with the toner image on the intermediate transfer belt 531, the resist roller pair 523 sends the sheet P to a secondary transfer portion disposed between the intermediate transfer belt 531 and a secondary transfer roller 535. At the secondary transfer portion, the color toner image on the intermediate transfer belt 531 is secondarily transferred onto the sheet P by the secondary transfer roller 535.

Subsequently, the sheet P having the image (toner image) formed thereon by the image forming units 510 is conveyed to a fixing apparatus (fixing unit) 100 illustrated in FIG. 2. The fixing apparatus 100 applies heat and pressure to the unfixed toner image (unfixed image) while nipping the sheet P at a fixing nip portion, to fix the toner image onto the sheet P. The sheet P passed through the fixing apparatus 100 is sent to the sheet wave correction apparatus 900 as a sheet processing apparatus for processing the sheet P by a discharge roller pair 540. Then, sheet wave correction is applied to the sheet P by the sheet wave correction apparatus 900 and then is discharged on a discharge tray 565.

The fixing apparatus 100 will be described below. The fixing apparatus 100 illustrated in FIG. 2 includes a fixing roller 110 as a heating rotary member and a pressure roller 111 as a pressure rotary member. The fixing roller 110 applies heat generated by an internal halogen heater (not illustrated) to toner on the sheet P and conveys the sheet P together with the pressure roller 111. The fixing roller 110 is composed of a metallic core made of an aluminum cylinder pipe, for example, having an outside diameter of 56 mm and an inside diameter of 50 mm, and a halogen heater incorporated in the metallic core. The surface of the metal core is coated with an elastic layer made of silicon rubber having, for example, a thickness of 2 mm and a hardness (Asker C) of 45 degrees, and the surface of the elastic layer is coated with a perfluoroalkoxy fluorine resin (PFA) or polytetrafluoroethylene (PTFE) heat-resistant mold release layer.

The pressure roller 111 illustrated in FIG. 2 conveys the sheet P together with the fixing roller 110. The pressure roller 111 also is composed of a metallic core made of an aluminum cylinder pipe having, for example, an outside diameter of 56 mm and an inside diameter of 50 mm. The surface of the metal core is coated with an elastic layer made of silicon rubber having, for example, a thickness of 2 mm and a hardness (Asker C) of 45 degrees, and the surface of the elastic layer is coated with a PFA or PTFE heat-resistant mold release layer.

The fixing nip portion is formed by the fixing roller 110 and the pressure roller 111 illustrated in FIG. 2. According to the present exemplary embodiment, the sheet P is conveyed at a sheet conveyance speed of about 300 to 500 mm/sec under conditions of a 180° C. temperature setting for the surface of the fixing roller 110, a 100° C. temperature setting for the surface of the pressure roller 111, a 23° C. environmental temperature, and a 50% environmental humidity. Then, after the sheet P is heated and pressurized in the fixing nip portion, paper fibers at the sheet edges in the width direction perpendicularly intersecting with the sheet conveyance direction are expanded in the sheet conveyance direction to a further extent than paper fibers at the sheet center. As a result, a wave occurs at sheet edges. Unless otherwise noted, the width direction refers to the direction perpendicularly intersecting with the sheet conveyance direction.

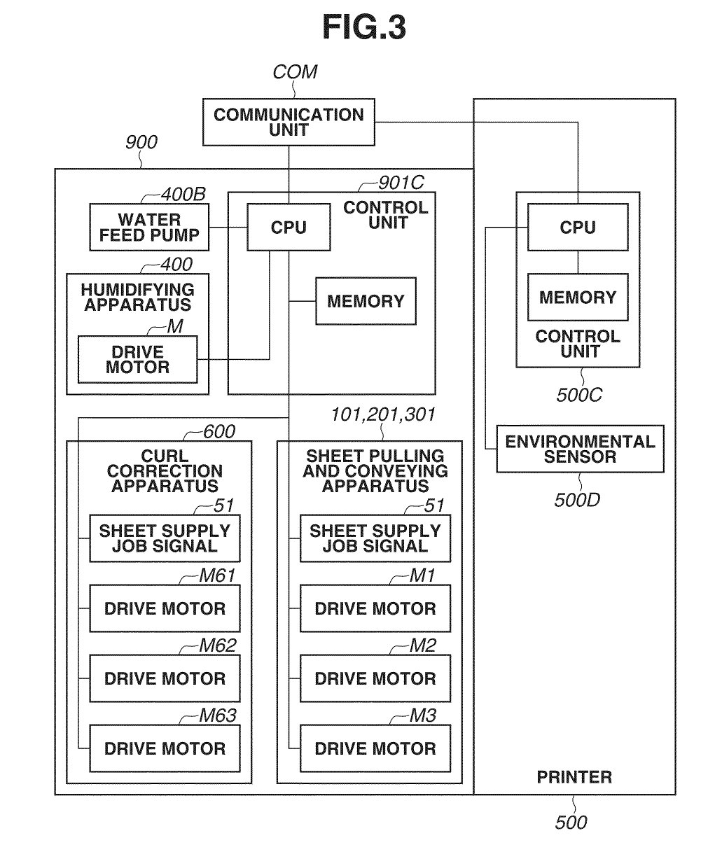

Paper type information for the sheet P in the sheet cassette 520 illustrated in FIG. 2 is input by a user using an operation panel 570, and is sent to a control unit 500C including a central processing unit (CPU) and a memory in the printer 500 illustrated in FIG. 3. Image density information for the toner image formed on the sheet P by the image forming units 510 is sent to the control unit 500C including the CPU and the memory. The temperature and humidity in the printer 500 are detected by an environmental sensor 500D disposed at the upper part of the sheet cassette 520 in the printer 500, and temperature and humidity information is sent to the control unit 500C including the CPU and the memory.

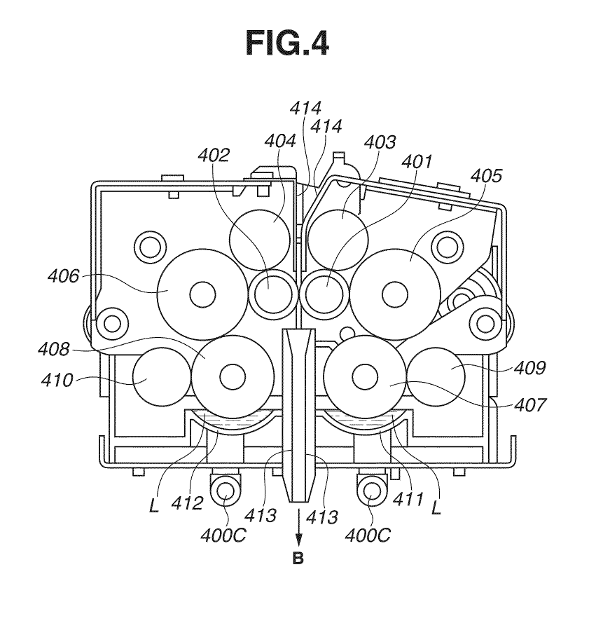

After the toner image on the sheet P is fixed by the fixing apparatus 100 illustrated in FIG. 2, the sheet P is sent to the sheet wave correction apparatus 900 by the discharge roller pair 540. The sheet P is conveyed by an entrance roller pair 901 of the sheet wave correction apparatus 900 along a conveyance guide 902. After the sheet conveyance direction is changed to the perpendicularly downward direction (the direction indicated by the arrow B illustrated in FIG. 2) by the conveyance guide 902, the sheet P is sent to the sheet humidifying device 400 as a moisture applying apparatus. The sheet P is humidified by humidifying rollers 401 and 402 illustrated in FIG. 4. A reservoir tank 400A stores humidification liquid L for humidifying the sheet P. The humidification liquid L stored in the reservoir tank 400A is supplied, as required, to supply vessels 411 and 412 (illustrated in FIG. 4) disposed in the sheet humidifying device 400 via the inside of a supply pipe 400H by a pump 400B. The humidification liquid L is mainly composed of water.

Subsequently, the sheet P discharged from the sheet humidifying device 400 illustrated in FIG. 2 is sent to the sheet pulling and conveying apparatuses 101 and 201 as tension applying apparatuses in this order. After the sheet P is humidified by the sheet humidifying device 400 with a predetermined amount of moisture or more, the sheet P sequentially passes through the sheet pulling and conveying apparatuses 101 and 201. The center of the sheet P in the width direction is pulled in the sheet conveyance direction to reduce the difference in the sheet length in the sheet conveyance direction between the sheet center and the sheet edges in the width direction.

After the wave at the edges of the sheet P in the width direction is corrected, the sheet P is sent to a decurling device (curl correction unit) 600 for correcting a curl occurring on the sheet P in the sheet pulling and conveying apparatuses 101 and 201.

After the curl is corrected, the sheet P is dried by a sheet drying apparatus 700 and is conveyed by a conveyance roller pair 904 while the sheet conveyance direction is changed to the perpendicularly upward direction (the direction indicated by the arrow C illustrated in FIG. 2) by conveyance guides 903 and 905. Subsequently, the sheet P is conveyed by the conveyance roller pairs 906 and 908 while being guided by conveyance guides 907 and 909, discharged to the outside of the sheet wave correction apparatus 900 by the discharge roller pair 910, and stacked on the discharge tray 565.

Overall control relations in the image forming apparatus will be described below with reference to FIG. 3. FIG. 3 is a block diagram illustrating overall control relations between the printer 500 as a main body of an image forming apparatus and the sheet wave correction apparatus 900 as a sheet processing apparatus. Each of the control unit 500C of the printer 500 and a control unit 901C of the sheet wave correction apparatus 900 is a computer system including a CPU, a memory, an operation unit, an input/output (I/O) port, a communication interface, a drive circuit, and the like.

Control by each of the control units 500C and 901C illustrated in FIG. 3 is implemented in such a manner that each CPU executes a predetermined program stored in the relevant memory. The control unit 901C of the sheet wave correction apparatus 900 controls operations of the sheet humidifying device 400, the sheet pulling and conveying apparatuses 101 and 201, and the decurling device 600 included in the sheet wave correction apparatus 900. The control units 500C and 901C are connected via a communication unit COM to enable information exchange between them.

Although the sheet wave correction apparatus 900 includes the control unit 901C and the printer 500 includes control unit 500C, the configuration is not limited thereto. For example, it is possible that the sheet wave correction apparatus 900 does not include the control unit 901C, and the control unit 500C included in the printer 500 controls operations of the sheet wave correction apparatus 900.

The sheet humidifying device 400 will be described in detail below with reference to FIG. 4. FIG. 4 is a sectional view illustrating the entire sheet humidifying device 400.

The arrow B illustrated in FIG. 4 indicates the same direction as the arrow B illustrated in FIG. 2. The sheet P is sent to the nip portion between the first humidifying rollers 401 and 402 while being guided by an approach guide 414, and is humidified with the humidification liquid L transferred onto the surface of the sheet P. After the sheet P passes through the nip portion between the humidifying rollers 401 and 402, the sheet P is sent to the first sheet pulling and conveying apparatus 101 via a discharge guide 413.

The humidifying rollers 401 and 402 are elastic rollers each being composed of a shaft core made of a metallic rigid body, such as stainless steel, and a solid rubber layer mainly made of nitrile rubber (NBR) and silicon formed on the surface of the shaft core.

Water supply rollers 405, 406, 407, and 408 are water supply members for sequentially supplying the humidification liquid L in supply the vessels 411 and 412 to the humidifying rollers 401 and 402, respectively. The water supply rollers 405, 406, 407, and 408 are elastic rollers each being composed of a shaft core made of a metallic rigid body, such as stainless steel, and a solid rubber layer mainly made of a material having a water-retentive (hydrophilic) surface, such as NBR, formed on the surface of the shaft core. The solid rubber layer may be a metal or a resin to which hydrophilic treatment is applied.

The water supply rollers 407 and 408 draw the humidification liquid L from the supply vessel 411 and 412, respectively, and then contact the water supply rollers 405 and 406, respectively, to supply the humidification liquid L to the water supply rollers 405 and 406. The water supply rollers 405 and 406 contact the humidifying rollers 401 and 402, respectively, to supply the humidification liquid L to the humidifying rollers 401 and 402.

First regulating rollers 409 and 410 are first regulating members for regulating the amount of water supply to the water supply rollers 407 and 408, respectively. Each of the first regulating rollers 409 and 410 is composed of a shaft core made of a metallic rigid body, such as stainless steel. Plating processing of nickel, chromium, or the like is applied to the surface of the first regulating rollers 409 and 410.

The first regulating rollers 409 and 410 contact the water supply rollers 407 and 408, respectively, to suitably regulate the amount of the humidification liquid L retained in the solid rubber layer surfaces of the respective water supply rollers to regulate the amount of moisture supplied to the sheet P. More specifically, the first regulating rollers 409 and 410 come in pressure-contact with the solid rubber layers of the water supply rollers 407 and 408, respectively, and deform them so that the humidification liquid L retained in the respective layer surfaces is extracted.

Second regulating rollers 403 and 404 are second regulating members for regulating the amount of water supply to the humidifying rollers 401 and 402, respectively. Each of the second regulating rollers 403 and 404 is composed of a shaft core made of a metallic rigid body, such as stainless steel. Plating processing of nickel, chromium, or the like is applied to the surface of the second regulating rollers 403 and 404.

The second regulating rollers 403 and 404 contact the humidifying rollers 401 and 402, respectively, to suitably regulate the amount of the humidification liquid L retained in the solid rubber layer surfaces of the respective humidifying rollers to regulate the amount of moisture supplied to the sheet P. More specifically, the second regulating rollers 403 and 404 come in pressure-contact with the solid rubber layers of the humidifying rollers 401 and 402, respectively, and deform them so that the humidification liquid L retained in the respective layer surfaces is extracted.

Thus, the sheet P is humidified by the optimal amount of moisture, and the effect of pulling the sheet P is promoted by the above-described sheet pulling and conveying apparatuses 101 and 201. The optimal amount of moisture for the sheet P is such an amount of moisture that separates hydrogen bonds between fibers of the sheet P.

A drive gear (not illustrated) is fixed on a shaft end side of the humidifying roller 402 to transmit rotation drive from a drive motor (not illustrated). Other rollers are rotatably driven by drive force transferred from the surface of the humidifying roller 402.

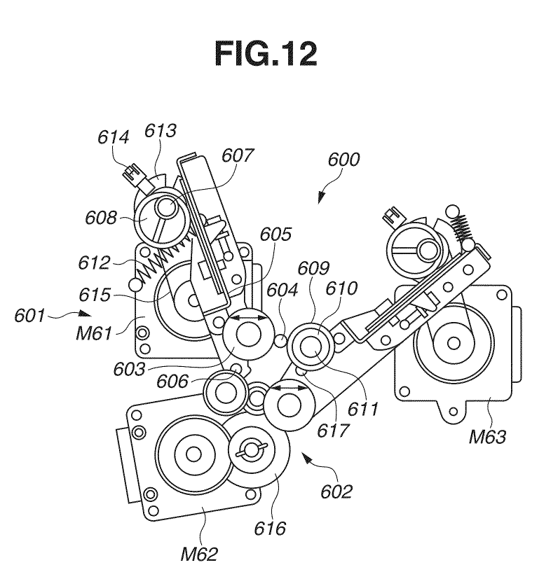

The decurling device 600 disposed on the downstream side of the sheet pulling and conveying apparatuses 101 and 201 in the sheet conveyance direction will be described below with reference to FIG. 12. The decurling device 600 includes a first curl correction unit 601 for correcting a convex sheet curl toward one surface side, and a second curl correction unit 602 for correcting a convex sheet curl toward the other surface side.

The first curl correction unit 601 includes a sponge roller 603, a rigid body roller 604, and a backup roller 609. The sponge roller 603 is composed of an elastic portion made of a sponge material, and a roller shaft made of a metallic rigid body at the center of the elastic portion. The rigid body roller 604 is a metal roller disposed in such a manner that the rigid body roller 604 faces the sponge roller 603. Both ends of the sponge roller 603 are supported by a retaining metal plate 605 which is rotatable around a rotation center 606. These members are integrally configured as an assembly.

An eccentric cam 608 which is rotatable around a rotation center shaft 607 is in sliding-contact with the retaining metal plate 605. When the eccentric cam 608 rotates, the above-described assembly rotates around the rotation center 606 whereby the sponge roller 603 comes in pressure-contact with the rigid body roller 604. Then, the amount of the sponge roller 603 pressed into the rigid body roller 604 can be changed by the rotational angle of the eccentric cam 608. Thus, the amount of curl correction on the sheet P can be changed.

Since the retaining metal plate 605 is urged toward the eccentric cam 608 by the spring force of a tension spring 612, the retaining metal plate 605 is constantly in contact with the outer circumferential surface of the eccentric cam 608. The outer circumferential surface of the backup roller 609 contacts the outer circumferential surface of the rigid body roller 604 to prevent the rigid body roller 604 from bending when it comes in pressure-contact with the sponge roller 603. The backup roller 609 is rotatable via a bearing 610 and a support shaft 611 on the inner circumferential surface.

A pulley 613 having an integrated rotation flag is fixed to an end of the rotation center shaft 607 of the eccentric cam 608, and is rotatable by a stepping motor M61 via a timing belt 615. The rotational position of the eccentric cam 608 is detected by a photo-interrupter 614, and the relevant position is maintained at a predetermined angle according to the rotational angle of the stepping motor M61.

The rigid body roller 604 rotates via a gear 616 connected with a motor M62 and another gear (not illustrated). The sponge roller 603 and the backup roller 609 are rotatably driven by the rotation of the rigid body roller 604.

With this configuration, the sponge roller 603 is in pressure-contact with the rigid body roller 604, the rigid body roller 604 is pressed into the sponge roller 603 so that a nip portion having a curved shape of the sponge roller 603 (hereinafter referred to as a curved nip portion) is formed. Referring to FIG. 12, when the sheet P having a curl convexed toward the right-hand side passes through the curve nip portion, the curl on the sheet P is corrected.

The amount of the rigid body roller 604 pressed into the sponge roller 603 changes according to the rotational position of the eccentric cam 608. Accordingly, the degree of curve of the curve nip portion also changes whereby it becomes possible to change the amount of curl correction for correcting the curl occurring on the sheet P. More specifically, the amount of curl correction can be adjusted according to the magnitude of the curl occurring on the sheet P.

In the second curl correction unit 602 illustrated in FIG. 12, since the positional relation between the sponge roller 603 and a rotation center 617 of the retaining metal plate 605 differs from the positional relation in the first curl correction unit 601, the rotational direction of the retaining metal plate 605 is opposite to the rotational direction in the first curl correction unit 601. However, the configuration for curl correction is similar to that in the first curl correction unit 601.

The second curl correction unit 602 corrects the sheet P having a curl convexed toward the opposite side of the curl in the first curl correction unit 601 (referring to FIG. 12, the sheet P having a curl convexed toward the left-hand side will be corrected). The adjustment of the amount of curl correction is performed by controlling the rotational angle of the stepping motor M63 to change the amount of the rigid body roller 604 pressed into the sponge roller 603 according to the rotational position of the eccentric cam 608 in a similar way to the first curl correction unit 601.

Similar to the first curl correction unit 601, the rigid body roller 604 rotates via the gear 616 connected with the motor M62 and another gear (not illustrated), and the sponge roller 603 and the backup roller 609 are rotatably driven by the rotation of the rigid body roller 604.

In order to decrease a curl caused by fixing or humidification, curl correction can further be improved by disposing the decurling device 600 on the downstream side of the sheet humidifying device 400 or the sheet pulling and conveying apparatuses 101 and 201. The amount of curl correction for the decurling device 600 can be made variable based on sheet information, image density information on the toner image formed on the sheet P, temperature and humidity information from the environmental sensor 500D, and humidification quantity information.

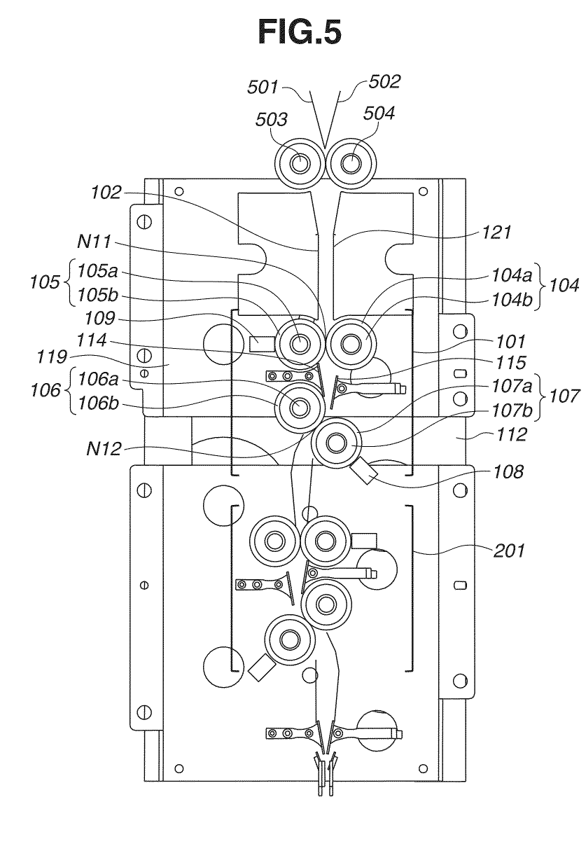

The configurations of the sheet pulling and conveying apparatuses 101 and 201 which characterize the present exemplary embodiment will be described below with reference to FIGS. 5, 7, and 8. In the present exemplary embodiment, the configurations of the sheet pulling and conveying apparatus 101 on the upstream side in the sheet conveyance direction and the sheet pulling and conveying apparatus 201 on the downstream side in the sheet conveyance direction are common. The configuration includes a plurality of roller pairs for applying a tension for expanding in the sheet conveyance direction the center of the sheet P in the width direction. Therefore, the configurations of the sheet pulling and conveying apparatuses 101 and 201 will be described below centering on the sheet pulling and conveying apparatus 101 on the upstream side, and detailed descriptions of the sheet pulling and conveying apparatus 201 on the downstream side will be omitted.

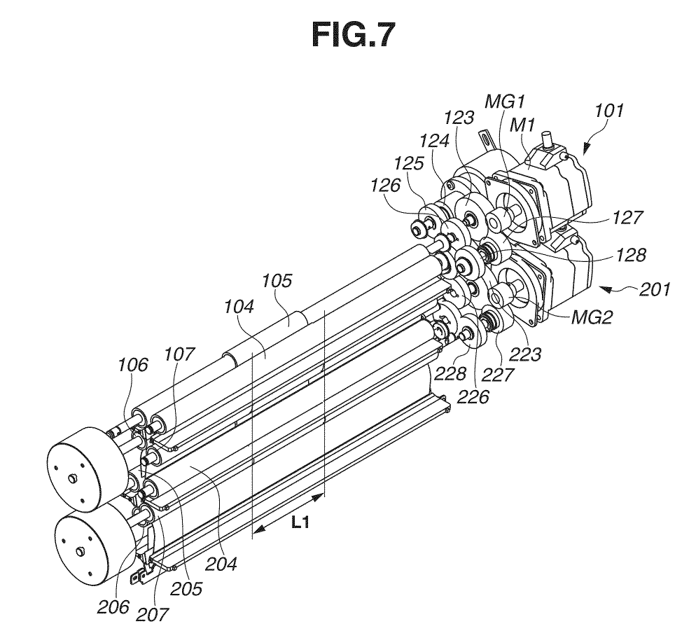

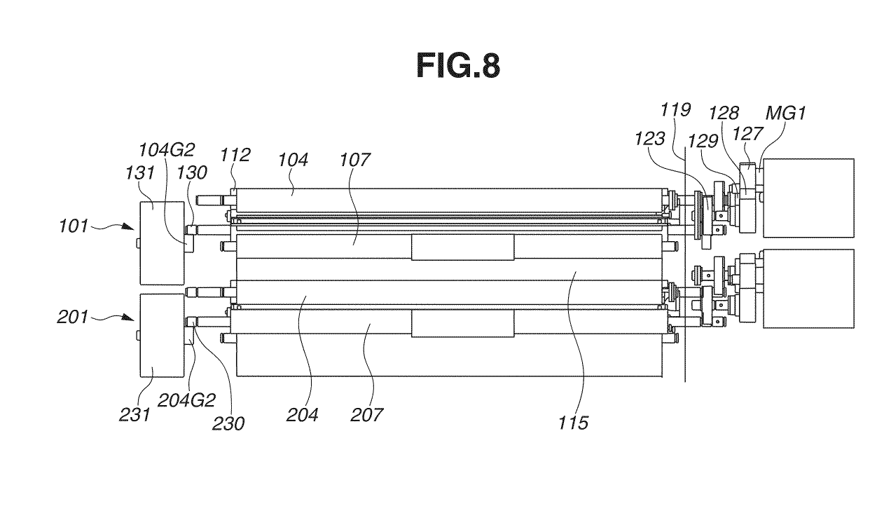

FIG. 5 is a front sectional view illustrating the sheet pulling and conveying apparatuses 101 and 201 according to the present exemplary embodiment. FIG. 7 is a perspective view illustrating the sheet pulling and conveying apparatuses 101 and 201 according to the present exemplary embodiment. FIG. 8 is another perspective view illustrating the sheet pulling and conveying apparatuses 101 and 201 according to the present exemplary embodiment.

The plurality of roller pairs includes a first roller pair (described below) and a second roller pair disposed on the downstream side of the first roller pair in the sheet conveyance direction.

The first roller pair (first rotary member pair) illustrated in FIG. 5 is composed of a first drive roller 104 as a first rotatable roller and a first pressure roller 105 as a first pressure roller. The first pressure roller 105 is in pressure-contact with the first drive roller 104 to form a nip portion N11 and the first pressure roller 105 and the first drive roller 104 nip and convey the sheet P.

The second roller pair (second rotary member pair) is disposed on the downstream side of the first roller pair in the sheet conveyance direction. The second roller pair is composed of a second drive roller 106 as a second rotatable roller and a second pressure roller 107 as a second pressure roller. The second pressure roller 107 is in pressure-contact with the second drive roller 106 to form a nip portion N12 and the second pressure roller 107 and the second drive roller 106 nip and convey the sheet P.

The sheet pulling and conveying apparatus 101 illustrated in FIG. 5 is configured to convey the sheet P in such a way that the sheet P is nipped and conveyed by the nip portion N11 formed between the first drive roller 104 and the first pressure roller 105 and the nip portion N12 formed between the second drive roller 106 and the second pressure roller 107. By conveying the sheet P while winding it around at least one roller of the first and the second roller pairs, the sheet pulling and conveying apparatus 101 applies a tension for expanding in the sheet conveyance direction the center of the sheet P in the width direction. A bending stress can be generated on the sheet P by conveying the sheet P while the sheet P is wound around relevant rollers.

The first drive roller 104, the first pressure roller 105, the second drive roller 106, and the second pressure roller 107 are composed of elastic rubbers 104b, 105b, 106b, and 107b, respectively, made of silicon, NBR, EPDM, or the like, as illustrated in FIG. 5. The elastic rubbers 104b, 105b, 106b, and 107b are respectively formed on the surfaces of roller shafts 104a, 105a, 106a, and 107a, respectively, made of a high rigidity material, such as stainless steel and iron steel. In the present exemplary embodiment, all of the elastic rubbers 104b, 105b, 106b, and 107b are assumed to have the same outside diameter φ (for example, 20 mm).

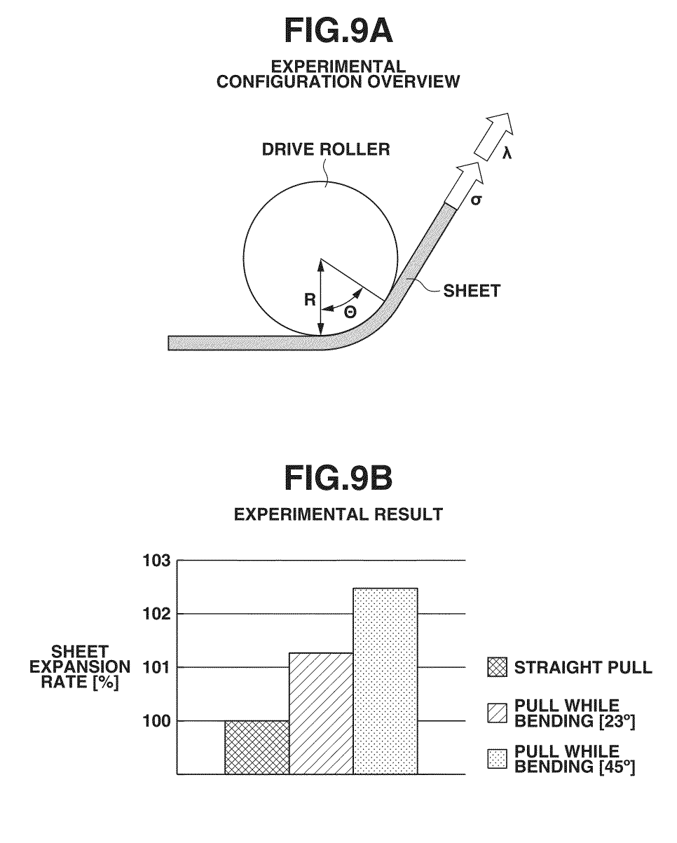

As illustrated in FIG. 7, each of the elastic rubber 105b of the first pressure roller 105 and the elastic rubber 107b of the second pressure roller 107 is formed in a range having a length L1 at the center in the sheet width direction so as to become uniform with respect to the sheet passing center (the center in the width direction). The sheet passing center refers to the center position in the width direction which serves as a reference position for sheet conveyance. The length L1 is shorter than the length of the maximum sheet P in the width direction in which a wave problem arises, as illustrated in FIG. 9A. Although, in the present exemplary embodiment, L1 is set to 100 mm, the length L1 needs to be shorter than the length of the maximum sheet P in the width direction. Although, in the present exemplary embodiment, the elastic rubber 105b of the first pressure roller 105 and the elastic rubber 107b of the second pressure roller 107 are 100 mm in width, the configuration is not limited thereto. For example, the first pressure roller 105 and the second pressure roller 107 may be formed over the entire range in the width direction, and the outside diameters of the elastic rubbers 105b and 107b at the center in the width direction are larger than the outside diameters thereof at the ends in the sheet width direction.

Referring to FIG. 5, an upper conveyance guide 114 and a lower conveyance guide 115 are disposed between the nip portion N11 formed by a first roller pair of rollers 104 and 105 and the nip portion N12 formed by a second roller pair of rollers 106 and 107. The distance between the nip portions is set to 25 mm.

As illustrated in FIGS. 5 and 8, the first drive roller 104 and the second drive roller 106 are supported on both ends of the roller shafts 104a and 106a, respectively, by an upper plate 119 via bearings.

The first pressure roller 105 is supported on both ends of the roller shaft 105a by a pressure plate 112 via a bearing (not illustrated). The first pressure roller 105 is urged by a first pressure spring 109 between the pressure plate 112 and a bearing (not illustrated). Thus, the first pressure roller 105 is pressed onto the first drive roller 104 to form the first nip portion N11. In the present exemplary embodiment, the urging force of the first pressure spring 109 is set so that the total roller pressure becomes around 98 N (10 kgf).

The second pressure roller 107 is supported on both ends of the roller shaft 107a by the pressure plate 112 via a bearing (not illustrated). The second pressure roller 107 is urged by a second pressure spring 108 between the pressure plate 112 and a bearing (not illustrated). Thus, the second pressure roller 107 is pressed onto the second drive roller 106 to form the second nip portion N12. In the present exemplary embodiment, the urging force of the second pressure spring 108 is set so that the pressure becomes around 98 N (10 kgf).

Referring to FIGS. 7 and 8, the first drive roller 104 is rotated by rotational drive force from a motor gear MG1 of a drive motor M1 as a drive source (drive unit) via drive transfer gears 123, 124, 125, and 126. The second drive roller 106 is rotated by rotational drive force via the drive transfer gears 123, 127, 128, and 129.

As illustrated in FIG. 7, the first pressure roller 105 pressurized by the first drive roller 104 is rotatably driven by the rotation of the first drive roller 104, and the second pressure roller 107 pressurized by the second drive roller 106 is rotatably driven by the rotation of the second drive roller 106.

The drive transfer gear 124 is provided with a one-way clutch in a drive transfer path between the first drive roller 104 and the drive motor M1. The one-way clutch is engaged when the first drive roller 104 rotates in the sheet conveyance direction by the drive of the drive motor M1.

The second drive roller 106 illustrated in FIG. 7 rotate at approximately the same sheet conveyance speed as that of an entrance roller pair 503 and 504. The sheet conveyance speed setting for the first drive roller 104 is smaller than that for the second drive roller 106. Therefore, when the sheet P having the maximum suppliable size is supplied, the sheet P does not bend between the first drive roller 104 and the second drive roller 106.

In the present exemplary embodiment, the sheet conveyance speed setting for the first drive roller 104 is about 2% smaller than the relevant setting for the second drive roller 106.

As illustrated in FIG. 8, a drive gear 104G2 is fixed to the other end of the first drive roller 104 so that the first drive roller 104 is connected with a torgue limiter (loading unit) 131 via a drive transfer gear 130. The torgue limiter 131 is configured so that, when the sheet P is nipped by the second roller pair of the rollers 106 and 107 and the first drive roller 104 rotates by the frictional force between the sheet P and the first drive roller 104, a drive load can be applied to the first drive roller 104. The loading unit may be not only a torque limiter but also an electromagnetic brake or a brake pad. With this configuration, when the sheet P is nipped by the first roller pair of the rollers 104 and 105 and the second roller pair of the rollers 106 and 107, a tensile stress occurs on the sheet P being conveyed by the second roller pair of the rollers 106 and 107. Operations when the sheet P is conveyed by the sheet pulling and conveying apparatus 101 will be described below.

The sheet P is guided to the entrance guides 102 and 121 in the sheet pulling and conveying apparatus 101 and then is nipped by the first nip portion N11 of the sheet pulling and conveying apparatus 101. The sheet P is conveyed by the first nip portion N11 at a sheet conveyance speed set to the first nip portion N11 until it is nipped by the second nip portion N12. In the present exemplary embodiment, the number of rotations of the drive motor M1 is set so that the sheet P is conveyed at a sheet conveyance speed of 294 mm/s by the first nip portion N11.

Then, when the sheet P is nipped by the second nip portion N12 of the sheet pulling and conveying apparatus 101, the sheet P is conveyed by the second nip portion N12 at a higher sheet conveyance speed than that of the first nip portion N11. In the present exemplary embodiment, the number of rotations is set so that the sheet P is conveyed at a sheet conveyance speed of 300 mm/s by the second nip portion N12 when the sheet P is conveyed at a sheet conveyance speed of 294 mm/s by the first nip portion N11. In this case, the second nip portion N12 on the downstream side in the sheet conveyance direction provides a higher sheet conveyance speed than the first nip portion N11 on the upstream side does. Therefore, the one-way clutch between the drive motor M1 and the first drive roller 104 runs idle. More specifically, since the drive is not transmitted to the first drive roller 104, the first roller pair of the rollers 104 and 105 is rotatably driven by the sheet P being conveyed by the second roller pair of the rollers 106 and 107. Since the torgue limiter 131 is connected to the first drive roller 104 via the drive gear 104G2 and the drive transfer gear 130, a torque load is generated to rotate the first drive roller 104. As a result, the sheet P is conveyed with a tension produced between the first roller pair of the rollers 104 and 105 and the second roller pair of the rollers 106 and 107. With this configuration, when the sheet P is nipped by the first roller pair of the rollers 104 and 105 and the second roller pair of the rollers 106 and 107, the sheet conveyance speed of each roller pair becomes approximately equal. This prevents image degradation on the sheet P. In the present exemplary embodiment, the setting value of the torgue limiter 131 is set so that a tension of 68 N (7 kgf) is applied to the sheet P when the same sheet P is present at both the first nip portion N11 and the second nip portion N12. The setting value of the torgue limiter 131 is set in such a range that a sufficient tension is applied to the sheet P but the sheet P is not damaged.

A conveyance locus formed by the sheet P between the first nip portion N11 and the second nip portion N12 when a tension is applied to the sheet P is referred to as a conveyance path. A conveyance path on the downstream side of the first roller pair of the rollers 104 and 105 in the sheet conveyance direction is referred to as a conveyance path C1, and a conveyance path on the upstream side of the second roller pair of the rollers 106 and 107 in the sheet conveyance direction is referred to as a conveyance path C2. When the sheet P is wound around a roller, the conveyance paths C1 and C2 are defined at a portion after the roller where the sheet P is separated from the roller. While a tension is applied to the sheet P by the above-described two different roller pairs which form the first nip portion N11 and the second nip portion N12, the sheet P comes to be wound around a part of the circumferential surface of the second drive roller 106. As a result, the sheet P is pulled while being bent.

The expansion of the sheet P achieved by pulling it while the sheet P is bent is expected to be larger than the expansion of the sheet P achieved by simply pulling it straight. Differences in expansion of the sheet P were compared and considered through an experiment. An experimental configuration overview and an experimental result are illustrated in FIGS. 9A and 9B. First of all, a sheet having a fixed thickness and a fixed width is wound around a drive roller having a radius R at a predetermined winding angle θ and then was pulled by a predetermined force σ. Then, the amount of expansion λ of the sheet P was measured (see FIG. 9A). FIG. 9B is a diagram illustrating the experimental result indicating the expansion rate before and after pulling the sheet P at different winding angles θ: 0 degrees, 23 degrees, and 45 degrees. The experimental result illustrated that the expansion of the sheet P achieved by pulling it while bending (θ=23 degrees, 45 degrees) is expected to be larger than the expansion of the sheet P achieved by simply pulling it straight in the sheet conveyance direction (θ=0 degrees). This tendency remained unchanged even if other factors R and σ were changed.

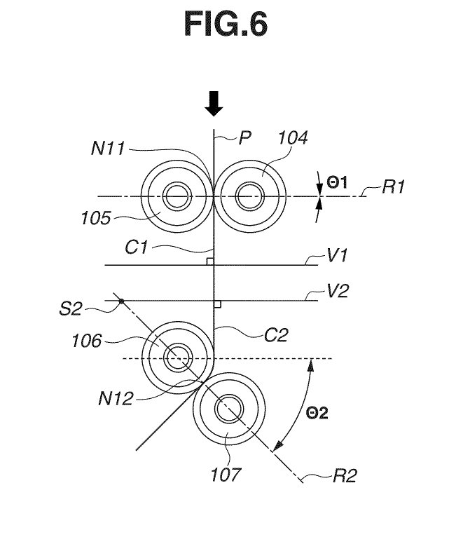

FIGS. 5 and 6 illustrate a configuration for pulling the sheet P while the sheet P is bent. A roller center line R1 connects the rotation center of the first drive roller 104 and the rotation center of the first pressure roller 105. Likewise, a roller center line R2 connects the rotation center of the second drive roller 106 and the rotation center of the second pressure roller 107.

The first roller pair of the rollers 104 and 105 is disposed perpendicularly to the conveyance paths C1 and C2, whereas the second roller pair of the rollers 106 and 107 is inclined with respect to the conveyance paths C1 and C2. Thus, making the roller center lines R1 and R2 not parallel realizes the configuration in which the sheet P is wound around at least one roller of the first and the second roller pairs.

Referring to FIG. 6, the angle at which the sheet P winds around the first drive roller 104 is referred to as a first winding angle θ1, and the angle at which the sheet P winds around the second drive roller 106 is referred to as a second winding angle θ2. The first winding angle θ1 is formed by the conveyance path C1 and the roller center line R1. The second winding angle θ2 is formed by the conveyance path C2 and the roller center line R2. In the present exemplary embodiment, the first roller pair of the rollers 104 and 105 is perpendicular to the sheet conveyance direction and therefore θ1=0.

In this case, the sheet P winds around the second drive roller 106 at the second winding angle θ2, and both a tensile stress and a bending stress are simultaneously applied to the sheet P. With the configuration in which the sheet P is pulled while a bending stress is applied to the sheet P, it becomes possible to apply a tension to the sheet P more efficiently than simply pulling the sheet P straight.

When both the tensile stress and the bending stress exceed the proof strength of the sheet P, a plastic expansion occurs on the sheet P.

The proof strength of the sheet P will be described below. With such materials as metal materials, measuring a yield point indicating a breakdown enables measuring a stress at the boundary between elastic deformation and plastic deformation (yield stress). Meanwhile, such materials as paper do not reveal a breakdown. With such material as paper, it is common to define a stress of when a predetermined plastic distortion occurs as a proof strength, which is equivalent to yield stress. In measurement of a stress-distortion diagram of a thin film such as paper, measurement can be performed with a general-purpose material testing machine by using a chuck for thin film with which paper is not slippery during measurement.

Generating a plastic expansion on the sheet P enables efficiently preventing a wave on the sheet P. Therefore, it is desirable that the sheet pulling and conveying apparatus 101 is configured to apply a stress exceeding the proof strength of the sheet P to the sheet P.

Although θ1<θ2 in the present exemplary embodiment, the configuration is not limited thereto. Since at least either one of the first and the second winding angles θ1 and θ2 needs to have a winding angle, either θ1>θ2 or 0<θ1=θ2 is applicable.

Referring to FIGS. 5 and 6, when a tension is applied to the sheet P while the sheet P winds around the second drive roller 106, the second drive roller 106 receives a reactive force from the sheet P. To stably apply a tension to the sheet P, the sheet P needs to receive a frictional force from the roller pair. Since the frictional force is proportional to the forces at the first nip portion N11 and the second nip portion N12 formed by the respective roller pairs, a predetermined force needs to be applied to the first nip portion N11 and the second nip portion N12. Suppose a roller pair with which one roller is a fixed roller that is only rotatably fixed to a side plate, and the other roller is a pressure roller movably disposed so as to be pressed onto the fixed roller by a predetermined urging force. In this case, when the roller around which the sheet P is wound is a pressure roller, the pressure roller may possibly move by the reactive force received from the sheet P. If the pressure roller moves, the pressure between the nip portion of the roller pair decreases, and a sufficient tension cannot be applied to the sheet P. Therefore, it is desirable that the roller around which the sheet P is wound is a fixed roller. In the present exemplary embodiment, the sheet P is wound around the drive roller 106 which is a fixed roller.

A positional relation of the fixed rollers will be described below with reference to FIG. 6. A perpendicular line V2 perpendicularly intersects with the conveyance path C2. The roller center line R2 intersects with the perpendicular line V2 at an intersecting point S2. When the distances between the respective center points of the roller pair and the point S2 are compared, the roller on the near side from the point S2 is the second drive roller (fixed roller) 106 and the roller on the far side from the point S2 is the second pressure roller (moving roller) 107. With this positional relation, the rollers around which the sheet P is wound are fixed rollers. The configuration illustrated in FIG. 6 according to the present exemplary embodiment illustrates the roller pair on the downstream side in the sheet conveyance direction. Likewise, also in a case where the sheet P is wound around the roller pair on the upstream side in the sheet conveyance direction, a sufficient tension can be applied to the sheet P by the configuration in which the roller around which the sheet P is wound is the fixed roller.

As described above, pressure needs to be stably applied to the first pressure roller 105 and the second pressure roller 107 respectively. To apply pressure more stably, it is desirable that any roller around which the sheet P is wound is fixed. Therefore, it is desirable that, in any roller pair, the roller around which the sheet P is wound is a roller that is only rotatable, and the other roller is a roller for applying pressure to the roller around which the sheet P is wound.

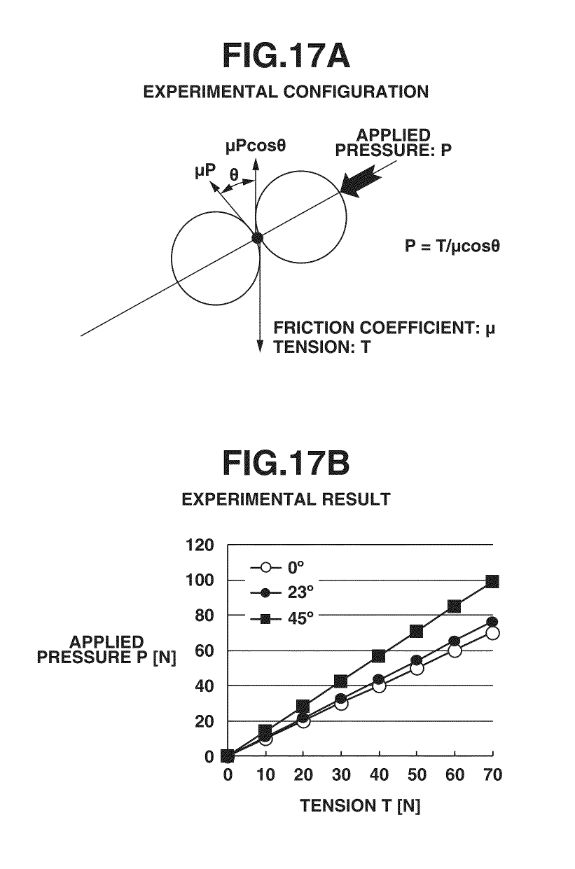

FIG. 17A is a diagram illustrating a configuration of a model for considering a minimum pressure of the first drive roller 104 required to stably convey the sheet P when the sheet P is wound around the first drive roller 104 illustrated in FIGS. 5 and 6. FIG. 17A illustrates a configuration overview and a relation between variables. The first pressure roller 105 applies pressure P to the first drive roller 104, and the first roller pair of the rollers 104 and 105 and the second roller pair of the rollers 106 and 107 (not illustrated) apply a tension T to the sheet P. The nip portion of the first roller pair of the rollers 104 and 105 has a friction coefficient μ. The sheet P winds around the first drive roller 104 at a winding angle θ. In the configuration as illustrated in FIG. 17A, the minimum required pressure P needs to satisfy P=T/μcos θ when the tension T is applied to the sheet P. FIG. 17B is a diagram illustrating a result of calculation when μ is a predetermined value. According to the formula P=T/μcos θ, the pressure P and the tension T have a proportionality relation, and a larger winding angle θ provides a larger pressure P. More specifically, as illustrated in FIGS. 5 and 6, the pressure P of when the sheet P is wound around the second roller pair of the rollers 106 and 107 and then is pulled, needs to be larger than the pressure P when the sheet P is simply pulled without being wound.

A relation between a plurality of sheet pulling and conveying apparatuses 101 and 201 will be described below. In the present exemplary embodiment, a plurality of sheet pulling and conveying apparatuses 101 and 201 is provided.

A plurality of sheet pulling and conveying apparatuses is provided to obtain a sufficient pulling effect on the sheet P. The pulling effect on the sheet P can be increased also by increasing the tension between the first nip portion N11 and the second nip portion N12. However, increasing the tension too much to rapidly apply a stress to the sheet P may cause much damage to the sheet P whereby the product quality may be degraded. Further, since the load for the second drive roller 106 to pull out the sheet P from the first nip portion N11 increases, a slip may arise within the second nip portion N12 whereby variation in the pulling effect on the sheet P and variation in the sheet conveyance speed may occur. Therefore, a plurality of sheet pulling and conveying apparatuses is installed to gradually pull the sheet P so that the pulling effect can be applied to the sheet P without these troubles. In the present exemplary embodiment, for example, when a tension of 98 N (10 kgf) or larger was applied to the sheet P, the damage to the sheet P increased and the product quality was degraded. Therefore, the torgue limiter 131 of the sheet pulling and conveying apparatus 101 and a torque limiter 231 of the sheet pulling and conveying apparatus 201 are set so that a tension of about 68 N (7 kgf) is applied to the sheet P during sheet conveyance.

As illustrated in FIG. 5, in the sheet pulling and conveying apparatuses 101 and 201, the rollers around which the sheet P is wound are disposed so as to be on opposite side from each other so that a bending stress toward the front surface of the sheet P (first surface) and a bending stress toward the back surface thereof (second surface on the opposite side of the first surface) are applied to the sheet P.

The reason will be described below with reference to FIG. 6.

In the sheet pulling and conveying apparatus 101, the front surface of the sheet P faces the second drive roller 106 and the back surface of the sheet P faces the second pressure roller 107.

As illustrated in FIG. 6, when the sheet P winds around the second drive roller 106 at a winding angle at a winding angle of θ2, the sheet becomes convex in the direction of the back surface. When the sheet P winds around the second drive roller 106, the front surface of the sheet P is closer to the rotation center of the second drive roller 106 on the sheet pulling and conveying apparatus 101 than the back surface. Therefore, the amount of expansion on the back surface of the sheet P as a result of the sheet P winding around the second drive roller 106 is larger than the amount of expansion on the front surface of the sheet P.

Therefore, after the sheet P passes through the sheet pulling and conveying apparatus 101, the curl on the sheet P can be reduced in such a manner that a bending stress is applied to the sheet P so that the sheet P curls in the opposite direction in the sheet pulling and conveying apparatus 201.

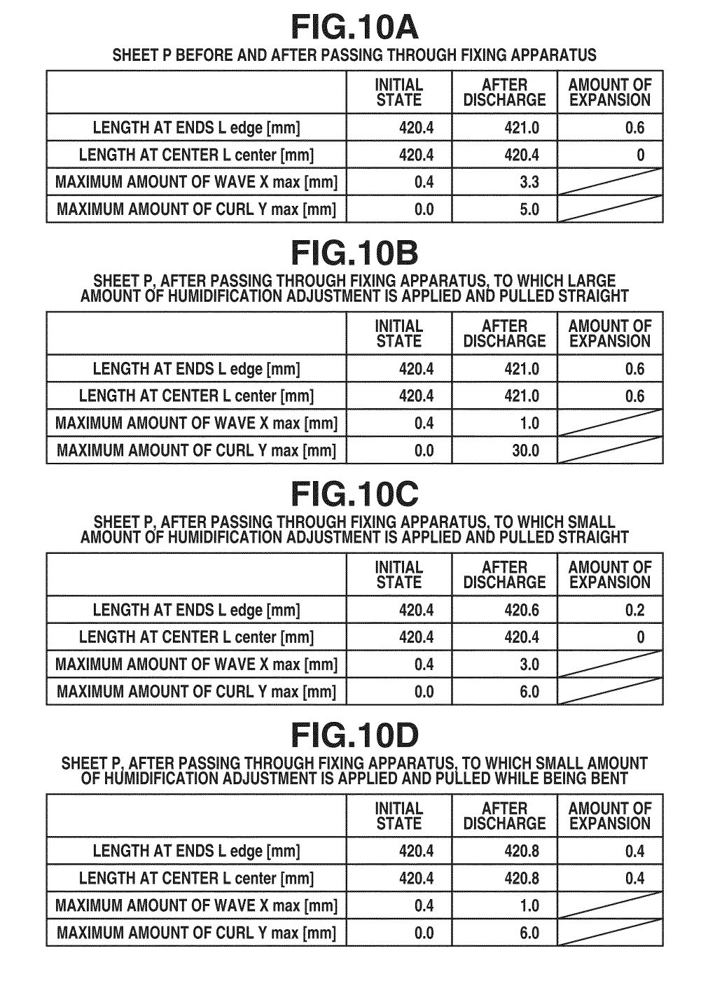

FIGS. 10A to 10D are diagrams each illustrating results of an effect verification experiment for the sheet pulling and conveying apparatuses 101 and 201 according to the present exemplary embodiment.

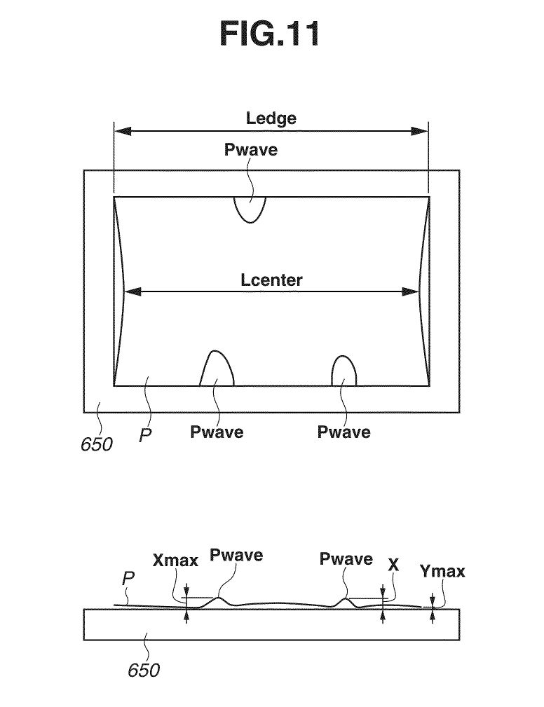

FIG. 11 illustrates a method for measuring the amount of wave and the amount of curl in the effect verification experiment for the sheet pulling and conveying apparatuses 101 and 201. Measurement was performed by placing the sheet P on a measurement surface plate 650. Curved shapes Pwave occurring at the upper and lower sides, i.e., the edges of the sheet P in the width direction perpendicularly intersecting with the sheet conveyance direction are referred to as edge waves. Among these edge waves, an edge wave having a maximum distance to the surface of the measurement surface plate 650 is referred to as a maximum amount of wave Xmax. Among the distances of the four corner edges of the sheet P from the measurement surface plate 650, the maximum distance is referred to as a maximum amount of curl Ymax and was subjected to evaluation. Further, a length at the edges (hereinafter referred to as an edge length Ledge) of the sheet P and a length at the sheet center (hereinafter referred to as a central length Lcenter) thereof were also measured.

As an experimental condition, a toner image was put on the front surface of the sheet P by 70%, and no toner image was put on the back surface thereof. Further, in order to perform the experiment with different amounts of sheet moisture, the following two different cases were considered: a case where the sheet P was not humidified by the sheet humidifying device 400 and a case where the sheet P was humidified by the sheet humidifying device 400 by applying different amounts of humidification.

The following describes a reason why a density difference was provided between the front and back surfaces of the sheet P as an experiment condition.

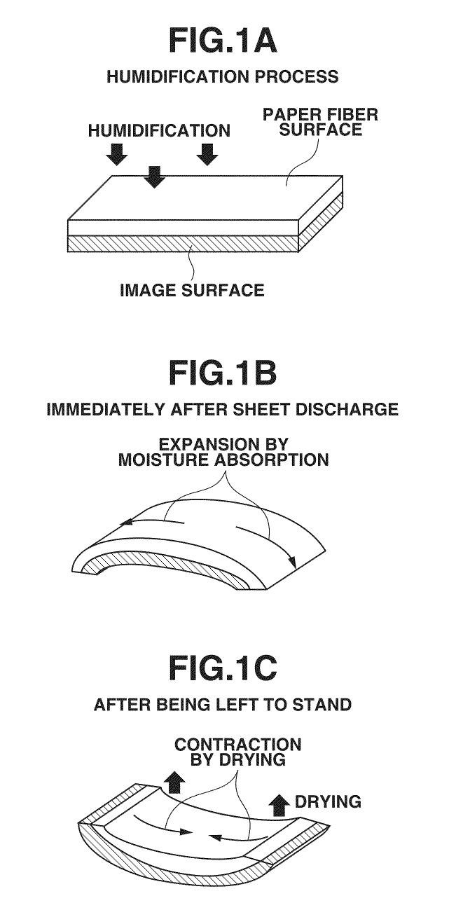

There has been a problem that a curl occurs if the sheet P having a density difference between the front and back surfaces is applied with humidification. A mechanism of curl occurrence is illustrated in FIGS. 1A, 1B, and 1C. In the example of the sheet P illustrated in FIGS. 1A to 1C, the front surface is the paper fiber surface with no image formed thereon, and the back surface is the image surface having a high toner density. When humidification is applied to the sheet P, which has an image density difference between the front and back surfaces, immediately after fixing (see FIG. 1A), moisture absorption actively occurs on the paper fiber surface. On the other hand, the image surface having a high toner density provides low moisture permeability of the toner layer, and therefore is harder to absorb moisture than the paper fiber surface. As a result, the paper fiber surface expands by moisture absorption and curls in a convex state with respect to the image surface having a high toner density (see FIG. 1B). Subsequently, the humidified sheet is left to stand in environment. Air in this environment is assumed to be at a temperature of 23° C. and a humidity of 50% (hereinafter referred to as a normal-temperature low-humidity environment). When the sheet P applied with humidification processing is left to stand in the normal-temperature low-humidity environment, the sheet P dries. Since moisture moves from the sheet P to the normal-temperature low-humidity environment by dryness, the sheet P contracts (see FIG. 1C). The amount of displacement according to the amount of moisture of the sheet P has a path dependency. The path dependency means that the amount of sheet contraction when drying is applied to the sheet P for a fixed amount of moisture is different from the amount of sheet expansion when humidification is applied to the sheet P with a fixed amount of moisture. More specifically, if any sheet is contracted by drying for a fixed amount of moisture and then expanded by humidification with the amount of moisture that has been lost from the sheet, the length of the sheet after expansion does not agree with the length before drying. As a result, since the amount of sheet expansion by moisture absorption differs from the amount of sheet contraction by drying, a curl remains after the sheet is left to stand.

To improve the curl correction immediately after discharge (see FIG. 1B), applying decurling to the sheet P by using a curl correction unit immediately after humidification prevents a curl immediately after the sheet P is discharged, but it does not prevent a curl after the sheet P is left to stand. Since a curl occurring after the sheet P is left to stand increases with increasing amount of humidification, it is desirable that the amount of humidification applied to the sheet P is as small as possible.

As described above, the effect verification experiment was performed under different image density conditions on the front and back surfaces of the sheet P, which largely affect a curl after the sheet P is left to stand.

The amount of sheet moisture according to the present exemplary embodiment was measured by using the sheet P immediately after the sheet P passed through the sheet wave correction apparatus 900 and then was discharged on the discharge tray 565. In the present exemplary embodiment, a microwave type paper moisture tester was used.

FIGS. 10A, 10B, 10C, and 10D are diagrams each illustrating experimental results including the amount of waves on the sheet P obtained under different conditions. Conditions of the sheet P before the sheet P passes through the fixing apparatus 100 are referred to as “Initial State”, and conditions of the sheet P after various processing is applied to the sheet P, and the sheet P is discharged and left to stand for a predetermined time period is referred to as “After Discharge.”

FIGS. 10A, 10B, 10C, and 10D illustrate results of measurement of waves after the sheet P passes through the fixing apparatus 100 and then different processing is applied to the sheet P. Conditions will be described below.
FIG. 10A: No particular processing was performed on the sheet P (the sheet P was not processed by the sheet humidifying device 400 and the sheet pulling and conveying apparatuses 101 and 201). (Comparative example over the present invention)
FIG. 10B: After the sheet P passed through the sheet humidifying device 400, humidification adjustment is applied to the sheet P with a large amount of sheet moisture, and the sheet P was then pulled straight by the sheet pulling and conveying apparatuses 101 and 201. Pulling straight refers to pulling the sheet at the winding angles θ1 and θ2 of 0 degrees. (Comparative example over the present invention)
FIG. 10C: After the sheet P passed through the sheet humidifying device 400, humidification adjustment is applied to the sheet P with a small amount of sheet moisture, and the sheet P was then pulled straight by the sheet pulling and conveying apparatuses 101 and 201. Pulling straight refers to pulling the sheet at the winding angles θ1 and θ2 of 0 degrees. (Comparative example over the present invention)
FIG. 10D: After the sheet P passed through the sheet humidifying device 400, humidification adjustment is applied to the sheet P with a small amount of sheet moisture. Then, the sheet P passed through the sheet pulling and conveying apparatuses 101 and 201 illustrated in FIG. 6 in which the sheet P was wound around the second drive roller 106 and then was pulled while being bent.

The experimental result illustrated in FIG. 10A will be described below. After the sheet P passed through the sheet humidifying device 400, the sheet P was not processed. The amount of expansion of the central length Lcenter of the sheet P was 0.0 mm and the amount of expansion of the edge length Ledge was 0.6 mm, i.e., the edge length Ledge was 0.6 mm longer than the central length Lcenter. As a result, the maximum amount of wave Xmax was as large as 3.3 mm, and the maximum amount of curl Ymax was 5.0 mm.

The experimental result illustrated in FIG. 10B will be described below. Immediately after the sheet P passed through the fixing apparatus 100, humidification adjustment was applied to the sheet P with a large amount of sheet moisture and then was pulled straight. The amount of expansion of the central length Lcenter of the sheet P was 0.6 mm, which is a sufficient pulling effect. The maximum amount of wave Xmax was 1.0 mm which is about one-third of the value in a case where no processing was performed. However, the maximum amount of curl Ymax increased by 30 mm.

The experimental result illustrated in FIG. 10C will be described below. Immediately after the sheet P passed through the fixing apparatus 100, humidification adjustment was applied to the sheet P with a small amount of sheet moisture and then was pulled straight. The central length Lcenter of the sheet P did not extend and a sufficient pulling effect was not obtained. The maximum amount of wave Xmax was 3.0 mm which remained comparatively large. The maximum amount of curl Ymax was 6.0 mm. It turned out that the amount of expansion of the sheet P illustrated FIG. 10C was smaller than that of the result illustrated in FIG. 10B. More specifically, it turned out that, with equal tensile stress, the amount of expansion of the sheet P increases with increasing amount of moisture contained in the sheet P.

The experimental result illustrated in FIG. 10D will be described below. Immediately after the sheet P passed through the fixing apparatus 100, humidification adjustment was applied to the sheet P with a small amount of moisture and the sheet P was then pulled while being bent. The amount of expansion of the central length Lcenter of the sheet P was 0.4 mm. It turns out that the pulling effect obtained by pulling the sheet P while the sheet P is bent is larger than the pulling effect obtained by simply pulling it. The maximum amount of wave Xmax was 1.0 mm which is about one-third of the value in a case where no processing was performed. The maximum amount of curl Ymax was 6.0 mm. It turns out that the maximum amount of curl Ymax is smaller than that in the case illustrated in FIG. 10B. This is because the amount of humidification applied to the sheet P can be reduced.

Correcting a wave and a curl of the sheet P in this way enables preventing conveyance failure, such as a sheet jam, and achieving stable sheet conveyance, thus achieving favorable sheet loading nature on the discharge tray 565.

As described above, a larger pulling effect on the sheet P than the conventional configuration in which the sheet P is simply pulled straight can be obtained by pulling the sheet P in such a manner that a bending stress is applied to the sheet P. With this method, improvement of sheet wave correction becomes easier. Further, there is a case of wave correction where humidification is applied to the sheet P before the sheet is pulled. This is because, even with equal tensile stress applied, the amount of expansion of the sheet P increases with increasing amount of moisture contained in the sheet P. However, there has been a problem that a curl occurs if humidification is applied to the sheet P having a density difference between the front and back surfaces is applied with a large amount of moisture. In the present exemplary embodiment, since the pulling effect on the sheet P can be improved compared with the conventional configuration in which the sheet P is simply pulled straight, the sheet P can be expanded without increasing the amount of moisture contained in the sheet P so much. Therefore, a curl due to humidification with a large amount of moisture can be reduced.

In the present exemplary embodiment, it is only necessary to shift the nip portion of the second roller pair of the rollers 106 and 107 whereby design of a conveyance path becomes easier than other exemplary embodiments (described below). Therefore, the present exemplary embodiment enables obtaining an effect of wave reduction by sheet winding while reducing the distance between the roller pair on the upstream side in the sheet conveyance direction and the roller pair on the downstream side in the sheet conveyance direction.

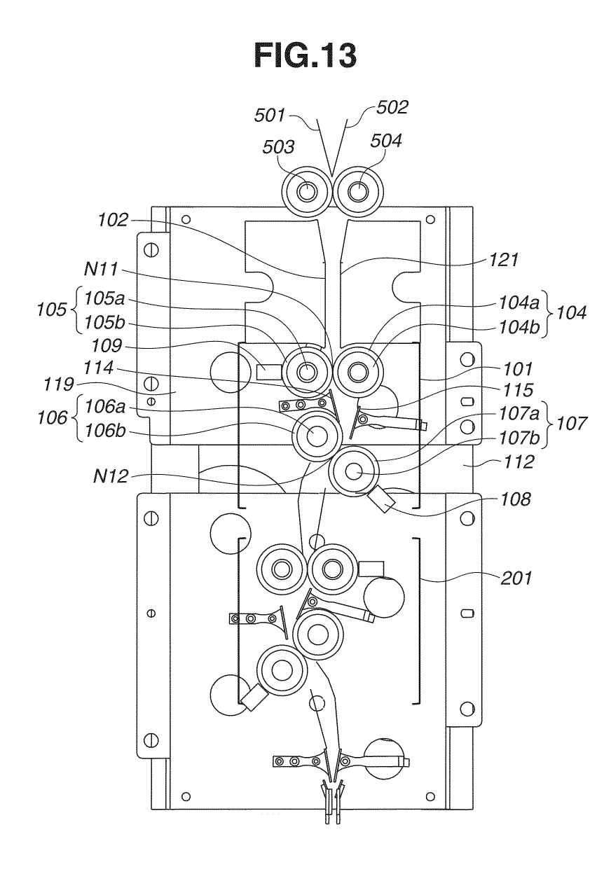

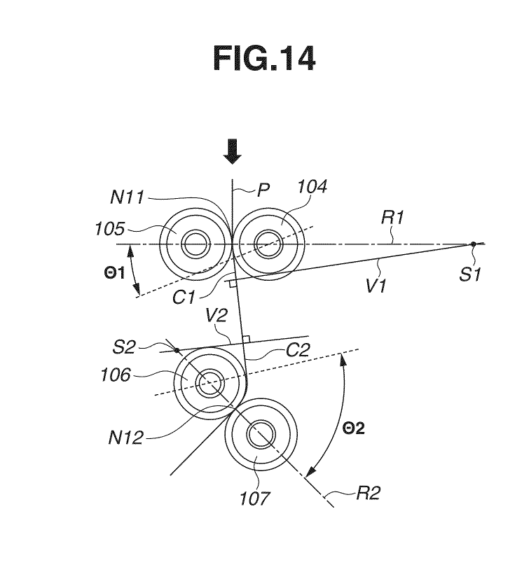

A second exemplary embodiment will be described below with reference to FIGS. 13 and 14. The present exemplary embodiment has a similar configuration to the first exemplary embodiment except that the sheet pulling and conveying apparatuses 101 and 201 in the sheet processing apparatus mechanism have been modified. Therefore, descriptions of elements other than the sheet pulling and conveying apparatuses 101 and 201 will be omitted.

The present exemplary embodiment differs from the first exemplary embodiment in that a first winding angle θ1 is larger than 0 (θ1>0). Referring to FIGS. 13 and 14, when a tension is applied to a sheet P, the sheet P forms a conveyance path between a first nip portion N11 and a second nip portion N12. The sheet P comes to be wound around a part of the circumferential surfaces of a first drive roller 104 and a second drive roller 106 while a tension is applied by the two roller pairs which form the first nip portion N11 and the second nip portion N12. As a result, the sheet P is pulled while being bent.

FIGS. 13 and 14 illustrate a configuration for pulling the sheet P while the sheet P is bent. A roller center line R1 connects the rotation center of the first drive roller 104 and the rotation center of a first pressure roller 105. Likewise, a roller center line R2 connects the rotation center of the second drive roller 106 and the rotation center of a second pressure roller 107. When a tension is applied to the sheet P, the sheet P forms a pulling and conveying path C1 on the downstream side of the first nip portion N11 in the sheet conveyance direction. Further, when a tension is applied to the sheet P on the upstream side of the second nip portion N12 in the sheet conveyance direction, the sheet P forms a pulling and conveying path C2. The sheet P can be wound around at least one roller of the first and the second roller pairs by the configuration in which the roller center lines R1 and R2 are not parallel.

An angle at which the sheet P winds around the second drive roller 106 is referred to as a second winding angle θ2. An angle at which the sheet P winds around the first drive roller 104 is referred to as a first winding angle θ1. The first winding angle θ1 is formed by the conveyance path C1 and the roller center line R1. The second winding angle θ2 is formed by the conveyance path C2 and the roller center line R2. In the present exemplary embodiment, the second winding angle θ2 is larger than the first winding angle θ1.

In this case, the sheet P winds around the second drive roller 106 at the second winding angle θ2, and both a large tensile stress and a large bending stress are simultaneously applied to the sheet P. When both the tensile stress and the bending stress exceed the proof strength of the sheet P, a plastic expansion occurs on the sheet P.

Referring to FIG. 14, when a tension is applied to the sheet P while the sheet P is wound around the first drive roller 104 and the second drive roller 106, the applied pressure to the sheet P between the nip portions of the roller pairs needs to be large to some extent, as described in the first exemplary embodiment.

In the present exemplary embodiment, the sheet P is wound around the first drive roller 104 and the second drive roller 106 which are fixed rollers only rotatably fixed to the side plate. This configuration prevents a decrease in the applied pressure at the nip portion of each roller pair.

A positional relation of fixed rollers will be described below with reference to FIG. 14. A perpendicular line V1 perpendicularly intersects with the conveyance path C1. The roller center line R1 intersects with the perpendicular line V1 at an intersecting point S1. A perpendicular line V2 perpendicularly intersects with the conveyance path C2. The roller center line R2 intersects with the perpendicular line V2 at an intersecting point S2. When the distances between the respective center points of the roller pair and the point S1 are compared, the roller on the near side from the point S1 is the first drive roller (fixed roller) 104 and the roller on the far side from the point S1 is the first pressure roller (moving roller) 105. When the distances between the respective center points of the roller pair and the point S2 are compared, the roller on the near side from the point S2 is the second drive roller (fixed roller) 106 and the roller on the far side from the point S2 is the second pressure roller (moving roller) 107. With this positional relation, the rollers around which the sheet P is wound are fixed rollers.

Similar to the first exemplary embodiment, the second exemplary embodiment enables improving the pulling effect on the sheet P. Further, in the second exemplary embodiment, the sheet P is wound around the first drive roller 104 and the second drive roller 106 respectively. Therefore, similar to the first exemplary embodiment, both a bending stress toward the surface of the sheet P in contact with the first drive roller 104 (first surface) and a bending stress toward the surface of the sheet P in contact with the second drive roller 106 (second surface on the opposite side of the first surface) are obtained. This enables obtaining an effect of preventing a curl on the sheet P. In the second exemplary embodiment, the above-described bending stresses in two different directions can be applied to the sheet P by using only the sheet pulling and conveying apparatus 101. This makes it possible to obtain an effect on downsizing of the apparatus compared with the effect obtained by the first exemplary embodiment.

In the present exemplary embodiment, larger winding angles than those in the first exemplary embodiment can be realized. This makes it possible to expect a larger sheet expansion than the experimental results of the first exemplary embodiment. Suppose that the sheet P is nipped by the first nip portion N11 formed by the first roller pair of the rollers 104 and 105 and the second nip portion N12 formed by the second roller pair of the rollers 106 and 107. When a tension is applied to the sheet P, the sheet P winds around the second drive roller 106. In this case, the second roller pair of the rollers 106 and 107 has an inclined angle with respect to the first roller pair of the rollers 104 and 105. Simultaneously, the second roller pair of the rollers 106 and 107 is disposed such that the second roller pair of the rollers 106 and 107 is translated to the right with respect to the first roller pair of the rollers 104 and 105 (refer to FIG. 13). By the above-described inclination angle and translation, the sheet P can wind around the second drive roller 106 with a larger second winding angle θ2 compared with the first and a third exemplary embodiments.

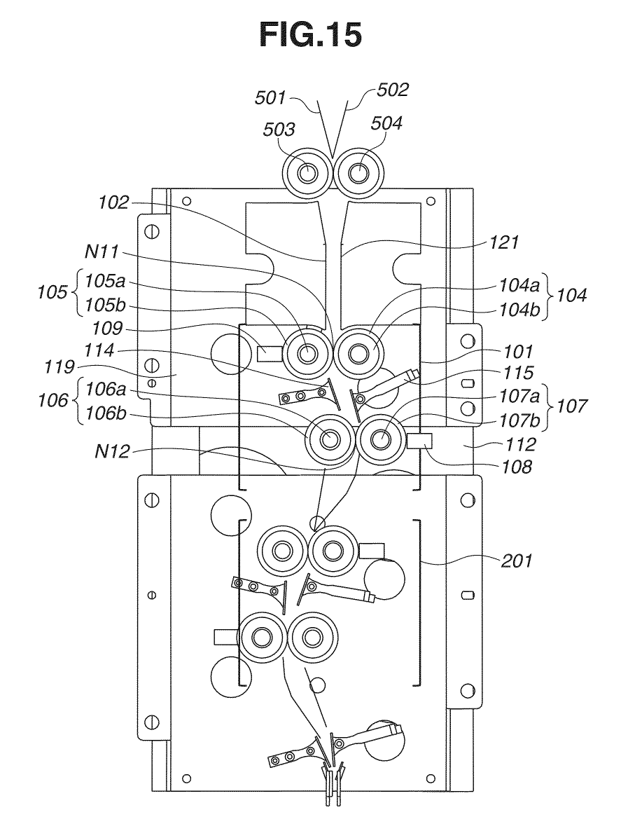

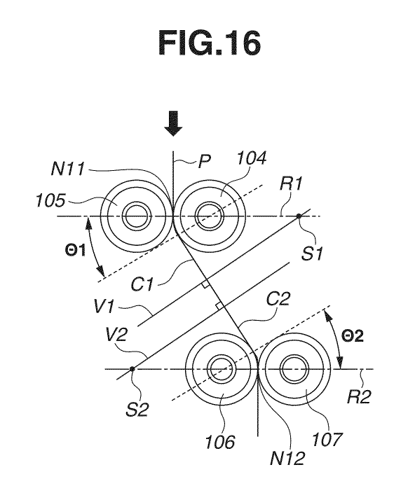

The third exemplary embodiment will be described below with reference to FIGS. 15 and 16. The present exemplary embodiment has a similar configuration to the first exemplary embodiment except that the sheet pulling and conveying apparatuses 101 and 201 in the sheet processing apparatus mechanism have been modified. Therefore, descriptions of elements other than the sheet pulling and conveying apparatuses will be omitted.

A conveyance locus formed by a sheet P between a first nip portion N11 and a second nip portion N12 when a tension is applied to the sheet P is referred to as a conveyance path. The conveyance path is approximated to the shortest path connecting the first nip portion N11 and the second nip portion N12. The sheet P comes to be wound around a part of circumferential surfaces of a first drive roller 104 and a second drive roller 106 while a tension is applied to the sheet P by the two roller pairs which form the first nip portion N11 and the second nip portion N12. As a result, the sheet P is pulled while being bent.

FIG. 16 illustrates a configuration in which the sheet P is pulled while being bent. A roller center line R1 connects the rotation center of the first drive roller 104 and the rotation center of a first pressure roller 105. Likewise, a roller center line R2 connects the rotation center of the second drive roller 106 and the rotation center of a second pressure roller 107.

Referring to FIG. 16, the roller center lines R1 and R2 are parallel. Meanwhile, when viewed from a direction perpendicular to the roller center line R1 (or the roller center line R2), the first nip portion N11 and the second nip portion N12 are in positions not overlapping each other. More specifically, it indicate the state that when the first nip portion N11 and the second nip portion N12 are projected on a virtual surface laterally perpendicular to paper of FIG. 16, the first nip portion N11 and the second nip portion N12 are in different positions from each other on the virtual surface.

Referring to FIG. 16, when a tension is applied to the sheet P while the sheet P is wound around the first drive roller 104 and the second drive roller 106, the applied pressure to the sheet P between the nip portions of the roller pairs needs to be large to some extent, as described in the first exemplary embodiment.

In the present exemplary embodiment, the sheet P is wound around the first drive roller 104 and the second drive roller 106 which are fixed rollers only rotatably fixed to the side plate. This configuration prevents a decrease in the applied pressure at the nip portion of each roller pair.

A positional relation of fixed rollers will be described below with reference to FIG. 16. A perpendicular line V1 perpendicularly intersects with the conveyance path C1. The roller center line R1 intersects with the perpendicular line V1 at an intersecting point S1. A perpendicular line V2 perpendicularly intersects with the conveyance path C2. The roller center line R2 intersects with the perpendicular line V2 at an intersecting point S2. When the distances between the respective center points of the roller pair and the point S1 are compared, the roller on the near side from the point S1 is the first drive roller (fixed roller) 104 and the roller on the far side from the point S1 is the first pressure roller (moving roller) 105. When the distances between the respective center points of the roller pair and the point S2 are compared, the roller on the near side from the point S2 is the second drive roller (fixed roller) 106 and the roller on the far side from the point S2 is the second pressure roller (moving roller) 107. With this positional relation, the rollers around which the sheet P is wound are fixed rollers.

Referring to FIG. 16, an angle at which the sheet P winds around the second drive roller 106 is referred to as a second winding angle θ2, and an angle at which the sheet P winds around the first drive roller 104 is referred to as a first winding angle θ1. In the present exemplary embodiment, the second winding angle θ2 and the first winding angle θ1 are equal.

In this case, the sheet P winds around the first drive roller 104 at the first winding angle θ1 or winds around the second drive roller 106 at the second winding angle θ2, and both a large tensile stress and a large bending stress are simultaneously applied to the sheet P. When both the tensile stress and the bending stress exceed the proof strength of the sheet P, a plastic expansion occurs on the sheet P. Further, both a bending stress toward the surface of the sheet P in contact with the first drive roller 104 (first surface) and a bending stress toward the surface of the sheet P in contact with the second drive roller 106 (second surface on the opposite side of the first surface) are obtained. This enables obtaining an effect of preventing a curl on the sheet P.

In the third exemplary embodiment, a simple configuration in which the first roller pair of the rollers 104 and 105 and the second roller pair of the rollers 106 and 107 are disposed in positions not overlapping each other in the positional relation therebetween, when viewed from a direction perpendicular to the roller center line R1 (or the roller center line R2) enables obtaining a similar effect to the effect obtained by the first and the second exemplary embodiments.

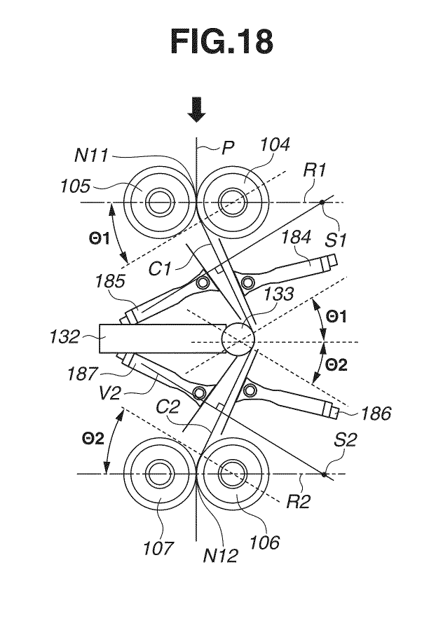

A fourth exemplary embodiment will be described below with reference to FIG. 18. The present exemplary embodiment has a similar configuration to the first exemplary embodiment except that the sheet pulling and conveying apparatuses 101 and 201 in the sheet processing apparatus mechanism have been modified. Therefore, descriptions of elements other than the sheet pulling and conveying apparatuses 101 and 201 will be omitted. A fourth exemplary embodiment is configured to obtain paper expansion by winding a sheet P around a roller 133 that is only rotatably fixed to a roller support 132, and then pulling the sheet P.

When the sheet P is conveyed to the sheet pulling and conveying apparatus illustrated in FIG. 18, the sheet P passes through a first nip portion N11 formed by a first drive roller 104 and a first pressure roller 105. Subsequently, being guided by sheet guides 184 and 185, the sheet P passes through a surface of the roller 133. Then, being guided by sheet guides 186 and 187, the sheet P passes through a second nip portion N12 formed by a second drive roller 106 and a second pressure roller 107. When the sheet P is simultaneously passing through the first nip portion N11 and the second nip portion N12, a tension is applied to the sheet P. When a tension is applied to the sheet P, the sheet P forms a conveyance path C1 between the first nip portion N11 and the roller 133, and forms a conveyance path C2 between the roller 133 and the second nip portion N12. More specifically, the roller 133 (guide member) contacts the sheet P so that the sheet P bends between the first roller pair of the rollers 104 and 105 and the second roller pair of the rollers 106 and 107. In the conveyance path C1, the sheet P winds around the first drive roller 104 and the roller 133 at a first winding angle θ1. Further, in the conveyance path C2, the sheet P winds around the roller 133 and the second drive roller 106 at a second winding angle θ2. Therefore, the sheet P is bent toward the first drive roller 104 by θ1+θ2. Further, the sheet P is bent toward the second drive roller 106 by θ1+θ2 by roller 133.

In this case, the sheet P winds around the first drive roller 104, the second drive roller 106, and the roller 133 at a winding angle of θ1+θ2, and both a tensile stress and a bending stress are simultaneously applied to the sheet P. When both the tensile stress and the bending stress exceed the proof strength of the sheet P, a plastic expansion occurs on the sheet P. Although θ1=θ2 in the present exemplary embodiment, the magnitude relation between θ1 and θ2 is not limited thereto. Magnitude relations θ1>θ2 and θ1<θ2 are also applicable.

Referring to FIG. 18, the sheet P is wound around the roller 133 (guide member) disposed between the first nip portion N11 and the second nip portion N12. However, the configuration is not limited to the one illustrated in FIG. 18. More specifically, there needs to be a guide member which contacts the sheet P so that the sheet P bends between the first roller pair of the rollers 104 and 105 and the second roller pair of the rollers 106 and 107 when the sheet P is nipped by the first roller pair of the rollers 104 and 105 and the second roller pair of the rollers 106 and 107. In the present exemplary embodiment, a roller is disposed to improve the sheet conveyance nature, a plate-shaped guide member may be provided instead of the roller.

Referring to FIG. 18, when a tension is applied to the sheet P while the sheet P is wound around the first drive roller 104 and the second drive roller 106, the applied pressure to the sheet P between the nip portions of the roller pairs needs to be large to some extent, as described in the first exemplary embodiment.

In the present exemplary embodiment, the sheet P is wound around the first drive roller 104 and the second drive roller 106 which are fixed rollers only rotatably fixed to the side plate. This configuration prevents a decrease in the applied pressure at the nip portion of each roller pair.

A positional relation of fixed rollers will be described below with reference to FIG. 18. A roller center line R1 connects the rotation center of the first drive roller 104 and the rotation center of the first pressure roller 105. Likewise, a roller center line R2 connects the rotation center of the second drive roller 106 and the rotation center of the second pressure roller 107. A perpendicular line V1 perpendicularly intersects with the conveyance path C1. The roller center line R1 intersects with the perpendicular line V1 at an intersecting point S1. A perpendicular line V2 perpendicularly intersects with the conveyance path C2. The roller center line R2 intersects with the perpendicular line V2 at an intersecting point S2. When the distances between the respective center points of the roller pair and the point S1 are compared, the roller on the near side from the point S1 is the first drive roller (fixed roller) 104 and the roller on the far side from the point S1 is the first pressure roller (moving roller) 105. When the distances between the respective center points of the roller pair and the point S2 are compared, the roller on the near side from the point S2 is the second drive roller (fixed roller) 106 and the roller on the far side from the point S2 is the second pressure roller (moving roller) 107. With this positional relation, the rollers around which the sheet P is wound are fixed rollers.

Further, both a bending stress toward the surface of the sheet P in contact with the first drive roller 104 (first surface) and a bending stress toward the surface of the sheet P in contact with the first pressure roller 105 (second surface on the opposite side of the first surface) at the roller 133 are obtained. This enables obtaining an effect of preventing a curl on the sheet P.

Also in the fourth exemplary embodiment, it is possible to obtain an effect of efficiently pulling the sheet P, similar to the first to the third exemplary embodiments.

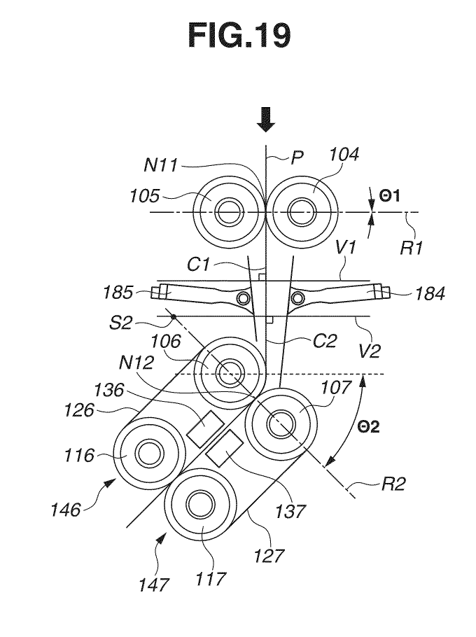

A fifth exemplary embodiment will be described below with reference to FIG. 19. The present exemplary embodiment has a similar configuration to the first exemplary embodiment except that the sheet pulling and conveying apparatuses 101 and 201 in the sheet processing apparatus mechanism have been modified. Therefore, descriptions of elements other than the sheet pulling and conveying apparatuses 101 and 201 will be omitted.

The present exemplary embodiment differs from the first exemplary embodiment in that a rotary member pair on the downstream side in the sheet conveyance direction is a belt pair. As illustrated in FIG. 19, the sheet P is wound around a second drive belt 146 and then pulled to achieve sheet expansion.

The belt pair is composed of the second drive belt 146 and a second pressure endless belt 127. The second drive belt 146 is composed of a second drive endless belt 126, a second drive roller 106, a second drive side endless belt roller 116, and a second drive side pressure pad 136. The second pressure endless belt 127 is composed of a second pressure endless belt 127, a second drive roller 106, a second pressure side endless belt roller 117, and a second pressure side pressure pad 137. A roller pair on the upstream side has an equivalent configuration to the first exemplary embodiment, detailed descriptions thereof will be omitted.

When a sheet P is conveyed to the sheet pulling and conveying apparatus illustrated in FIG. 19, the sheet P passes through a first nip portion N11 formed by the first drive roller 104 and the first pressure roller 105. Then, being guided by the sheet guides 184 and 185, the sheet P passes through a second nip portion N12 formed by the second drive belt 146 and the second pressure belt 147. When the sheet P is simultaneously passing through the first nip portion N11 and the second nip portion N12, a tension is applied to the sheet P. When a tension is applied to the sheet P, the sheet P forms a conveyance path C1 on the downstream side of the first nip portion N11. Further, the sheet P forms a conveyance path C2 on the upstream side of the second nip portion N12. Referring to FIG. 19, the conveyance path C1 and the conveyance path C2 are on an identical straight line. In the conveyance path C2, the sheet P winds around the second drive belt 146 at a second winding angle θ2.

In this case, the sheet P winds around the second drive belt 146 at the second winding angle θ2, and both a tensile stress and a bending stress are simultaneously applied to the sheet P. By pulling the sheet P while a bending stress is applied to the sheet P in this way, it becomes possible to apply a tension to the sheet P more efficiently than simply pulling the sheet P straight. When both the tensile stress and the bending stress exceed the proof strength of the sheet P, a plastic expansion occurs on the sheet P.

Although θ1=θ2 in the present exemplary embodiment, the magnitude relation between θ1 and θ2 is not limited thereto. Magnitude relations θ1>θ2 and θ1<θ2 are applicable.

FIG. 19 illustrates a configuration in which the sheet P is pulled while being bent. A roller center line R1 connects the rotation center of the first drive roller 104 and the rotation center of the first pressure roller 105. Likewise, a roller center line R2 connects the rotation center of the second drive roller 106 and the rotation center of the second pressure roller 107.

The second belt pair of the rollers 146 and 147 is inclined with respect to the first roller pair of the rollers 104 and 105 disposed perpendicularly to the conveyance path C2.

With the configuration in which the roller center lines R1 and R2 are not parallel, the sheet P can be wound around at least one roller of the first roller pair and the second belt pair.

When the first rotary member pair is a belt pair, a center line R1 connects the rotation center of the roller pair, among the belt stretching rollers, on the downstream side in the sheet conveyance direction. On the other hand, when the second rotary member pair is a belt pair, a center line R2 connects the rotation center of the roller pair, among the belt stretching rollers, on the upstream side in the sheet conveyance direction.

Referring to FIG. 19, when a tension is applied to the sheet P while the sheet P is wound around the second drive belt 146, the applied pressure between the nip portions of the roller pairs needs to be large to some extent, as described in the first exemplary embodiment.

In the present exemplary embodiment, the second drive roller 106 for stretching the second drive belt 146 is a fixed roller that is only rotatably fixed to the side plate. This configuration prevents a decrease in the applied pressure at the nip portion of each belt pair.

When the rotary member pair on the downstream side in the sheet conveyance direction is a belt pair, it is important that the roller around which the sheet P is wound is a fixed roller among the belt stretching rollers disposed on the upstream side in the sheet conveyance direction.

A positional relation of fixed roller will be described below with reference to FIG. 19. A perpendicular line V2 perpendicularly intersects with the conveyance path C2. The roller center line R2 intersects with the perpendicular line V2 at an intersecting point S2. When the distances between the respective center points of the roller pair and the point S2 are compared, the roller on the near side from the point S2 is the second drive roller (fixed roller) 106 and the roller on the far side from the point S2 is the second pressure roller (moving roller) 107. With this positional relation, the belt stretching roller around which the sheet P is wound is a fixed roller.

In the configuration according to the present exemplary embodiment illustrated in FIG. 19, the rotary member pair on the downstream side in the sheet conveyance direction is a belt pair. Likewise, also in a case where the sheet P is wound around the belt pair disposed on the upstream side in the sheet conveyance direction, a sufficient tension can be applied to the sheet P in such a manner that the sheet P is wound around a fixed roller out of the belt stretching rollers. When a belt pair is disposed on the upstream side in the sheet conveyance direction, it is important that the roller around which the sheet P is wound is a fixed roller among the belt stretching rollers disposed on the downstream side in the sheet conveyance direction.

As described above, even in a case where a belt pair is used as a rotary member pair, instead of a roller pair, a similar effect to the effect obtained by the first exemplary embodiment can be obtained. Further, in the configurations according to the second to the fourth exemplary embodiments, a similar effect can be obtained even if the roller pair is replaced with a belt pair.

Although, in the fifth exemplary embodiment, the second rotary member pair on the downstream side in the sheet conveyance direction is a belt pair, the configuration is not limited thereto. The rotary member pair on the upstream side in the sheet P conveyance direction may be a belt pair.

As described above, also in the fifth exemplary embodiment, it is possible to obtain an effect that the sheet P is effectively pulled, similar to the effect obtained by the first to the fourth exemplary embodiments.

Further, the conveyance force can be improved by replacing the roller pair configurations according to the first to the fourth exemplary embodiments with the belt pair configuration.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-187923, filed Sep. 16, 2014, which is hereby incorporated by reference herein in its entirety.

What is claimed is:

1. A sheet processing apparatus comprising:
a first rotary member pair configured to nip a sheet at a nip portion and convey the sheet;
a second rotary member pair disposed on a downstream side of the first rotary member pair in a sheet conveyance direction, and configured to nip the sheet at a nip portion and convey the sheet; and
a loading unit configured to, when the sheet is nipped by the first and the second rotary member pairs, apply a load to a rotation of the first rotary member pair so that a tensile stress occurs on the sheet being conveyed by the second rotary member pair,
wherein, when the sheet is nipped by the first and the second rotary member pairs, a bending stress occurs on the sheet.

2. The sheet processing apparatus according to claim 1, wherein, in a sectional view perpendicular to a sheet surface and parallel to the sheet conveyance direction, at least a part of the sheet conveyance path when the sheet is nipped by the first and the second rotary member pairs is formed along a circumferential surface of the first or the second rotary member pair.

3. The sheet processing apparatus according to claim 1, wherein a sheet width direction is a direction perpendicular to the sheet conveyance direction, and
wherein at least one of rotary members configuring the first or the second rotary member pair has a roller outside diameter that is larger at a center in the sheet width direction perpendicular to the sheet conveyance direction than a roller outside diameter at sheet edges in the sheet width direction.

4. The sheet processing apparatus according to claim 1, wherein a bending stress applied to the sheet during sheet conveyance includes both a bending stress toward a first surface of the sheet and a bending stress toward a second surface which is an opposite side of the first surface.

5. The sheet processing apparatus according to claim 1, wherein a rotary member around which the sheet is wound during sheet conveyance is rotatably and fixedly disposed.

6. The sheet processing apparatus according to claim 1, further comprising:
a moisture applying unit configured to supply moisture to the sheet,
wherein the moisture applying unit is disposed on an upstream side of the first rotary member pair in the sheet conveyance direction.

7. The sheet processing apparatus according to claim 1, further comprising:
a curl correction unit configured to correct a curl on the sheet,
wherein the curl correction unit is disposed on a downstream side of the second rotary member pair in the sheet conveyance direction.

8. The sheet processing apparatus according to claim 1, wherein the first or the second rotary member pair is a roller pair.

9. The sheet processing apparatus according to claim 1, wherein the first or the second rotary member pair is a belt pair stretched by a plurality of rollers.

10. The sheet processing apparatus according to claim 1, wherein the loading unit is a torque limiter.

11. The sheet processing apparatus according to claim 1, wherein a one-way clutch is provided in a drive transfer path between the first rotary member pair and a drive motor for applying drive to the first rotary member pair.

12. An image forming apparatus comprising:
a fixing unit configured to thermally fix an unfixed image formed on a sheet; and
the sheet processing apparatus according to claim 1 for performing processing on the sheet having the image fixed thereon.

13. A sheet processing apparatus comprising:
a first rotary member pair configured to nip a sheet at a nip portion and convey the sheet;
a second rotary member pair disposed on a downstream side of the first rotary member pair in a sheet conveyance direction, and configured to nip the sheet at a nip portion and convey the sheet; and
a loading unit configured to, when the sheet is nipped by the first and the second rotary member pairs, apply a load to a rotation of the first rotary member pair so that a tensile stress occurs on the sheet being conveyed by the second rotary member pair,
wherein, in a sectional view perpendicular to a sheet surface and parallel to the sheet conveyance direction, a line connecting rotation centers of the first rotary member pair and a line connecting rotation centers of the second rotary member pair are not parallel.

14. The sheet processing apparatus according to claim 13, wherein, in a case where the first rotary member pair is a roller pair, the line connecting the rotation centers of the first rotary member pair is a line connecting rotation centers of the roller pair,
wherein, in a case where the first rotary member pair is a belt pair, the line connecting the rotation centers of the first rotary member pair is a line connecting rotation centers of roller pair on a downstream side in the sheet conveyance direction among rollers for stretching the belt,
wherein, in a case where the second rotary member pair is a roller pair, the line connecting the rotation centers of the second rotary member pair is a line connecting rotation centers of the roller pair, and
wherein, in a case where the second rotary member pair is a belt pair, the line connecting the rotation centers of the second rotary member pair is a line connecting rotation centers of roller pair on an upstream side in the sheet conveyance direction among rollers for stretching the belt.

15. The sheet processing apparatus according to claim 13, wherein a sheet width direction is a direction perpendicular to the sheet conveyance direction, and
wherein at least one of rotary members configuring the first or the second rotary member pair has a roller outside diameter that is larger at a center in the sheet width direction perpendicular to the sheet conveyance direction than a roller outside diameter at an edge in the sheet width direction.

16. The sheet processing apparatus according to claim 13, wherein a bending stress applied to the sheet during sheet conveyance includes both a bending stress toward a first surface of the sheet and a bending stress toward a second surface which is an opposite side of the first surface.

17. The sheet processing apparatus according to claim 13, wherein a rotary member around which the sheet is wound during sheet conveyance is rotatably and fixedly disposed.

18. A sheet processing apparatus comprising:
a first rotary member pair configured to nip a sheet at a nip portion and convey the sheet;
a second rotary member pair disposed on a downstream side of the first rotary member pair in a sheet conveyance direction, and configured to nip the sheet at a nip portion and convey the sheet; and
a loading unit configured to, when the sheet is nipped by the first and the second rotary member pairs, apply a load to a rotation of the first rotary member pair so that a tensile stress occurs on the sheet being conveyed by the second rotary member pair,
wherein, in a sectional view perpendicular to a sheet surface and parallel to the sheet conveyance direction, a line connecting rotation centers of the first rotary member pair and a line connecting rotation centers of the second rotary member pair are parallel, and, when viewed from a direction perpendicular to the lines connecting the rotation centers, the nip portion of the first rotary member pair and the nip portion of the second rotary member pair are in positions not overlapping each other.

19. The sheet processing apparatus according to claim 18, wherein, in a case where the first rotary member pair is a roller pair, the line connecting the rotation centers of the first rotary member pair is a line connecting rotation centers of the roller pair,
wherein, in a case where the first rotary member pair is a belt pair, the line connecting the rotation centers of the first rotary member pair is a line connecting rotation centers of roller pair on a downstream side in the sheet conveyance direction among rollers for stretching the belt,
wherein, in a case where the second rotary member pair is a roller pair, the line connecting the rotation centers of the second rotary member pair is a line connecting rotation centers of the roller pair, and
wherein, in a case where the second rotary member pair is a belt pair, the line connecting the rotation centers of the second rotary member pair is a line connecting rotation centers of roller pair on an upstream side in the sheet conveyance direction among rollers for stretching the belt.

20. The sheet processing apparatus according to claim 19, wherein a sheet width direction is a direction perpendicular to the sheet conveyance direction, and
wherein, at least one of rotary members configuring the first or the second rotary member pair has a roller outside diameter that is larger at a center in the sheet width direction perpendicular to the sheet conveyance direction than a roller outside diameter at an edge in the sheet width direction.

21. The sheet processing apparatus according to claim 19, wherein a bending stress applied to the sheet during sheet conveyance includes both a bending stress toward a first surface of the sheet and a bending stress toward a second surface which is an opposite side of the first surface.

22. The sheet processing apparatus according to claim 19, wherein a rotary member around which the sheet is wound during sheet conveyance is rotatably and fixedly disposed.

23. A sheet processing apparatus comprising:
a first rotary member pair configured to nip a sheet at a nip portion and convey the sheet;
a second rotary member pair disposed on a downstream side of the first rotary member pair in a sheet conveyance direction, and configured to nip the sheet at a nip portion and convey the sheet;
a loading unit configured to, when the sheet is nipped by the first and the second rotary member pairs, apply a load to a rotation of the first rotary member pair so that a tensile stress occurs on the sheet being conveyed by the second rotary member pair; and
a guide member disposed between the first and the second rotary member pairs,
wherein, when the sheet is nipped by the first and the second rotary member pairs, the guide member contacts the sheet so that the sheet bends between the first and the second rotary member pairs.

24. The sheet processing apparatus according to claim 23, wherein, at a position of the guide member in contact with the sheet, a roller which rotates by sheet conveyance is disposed.

25. The sheet processing apparatus according to claim 23, wherein a sheet width direction is a direction perpendicular to the sheet conveyance direction, and
wherein, at least one of rotary members configuring the first or the second rotary member pair has a roller outside diameter that is larger at a center in the sheet width direction perpendicular to the sheet conveyance direction than a roller outside diameter at an edge in the sheet width direction.

26. The sheet processing apparatus according to claim 23, wherein a bending stress applied to the sheet during sheet conveyance includes both a bending stress toward a first surface of the sheet and a bending stress toward a second surface which is an opposite side of the first surface.

27. The sheet processing apparatus according to claim 23, wherein a rotary member around which the sheet is wound during sheet conveyance is rotatably and fixedly disposed.
